(19) United States
(12) Patent Application Publication
(10) Pub. No.: US 2007/0032377 A1
(43) Pub. Date: Feb. 8, 2007

(54) Process for preparing shaped catalyst bodies whose active composition is a multielement oxide

(75) Inventors: Hartmut Hibst, Schriesheim (DE); Raimund Felder, Neustadt (DE); Heiko Arnold, Nanjing (CN); Andreas Raichle, Ludwigshafen (DE); Klaus Joachim Muller-Engel, Stutensee (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/498,795

(22) Filed: Aug. 4, 2006

Related U.S. Application Data
(60) Provisional application No. 60/705,485, filed on Aug. 5, 2005.

(30) Foreign Application Priority Data
Aug. 5, 2005 (DE) 102005037678.9

(51) Int. Cl. B01J 21/02; B29C 67/00

(52) U.S. Cl. 502/202; 264/117

(57) ABSTRACT

A process for preparing shaped catalyst bodies whose active composition is a multielement oxide, in which a finely divided precursor mixture is shaped to a desired geometry with addition of boron nitride and subsequently treated thermally.

The present invention relates to a process for preparing shaped catalyst bodies whose active composition is a multielement oxide, in which a finely divided precursor mixture which comprises an added finely divided shaping assistant is shaped (compacted) to the desired geometry and the resulting shaped catalyst precursor bodies are treated thermally at elevated temperature to obtain shaped catalyst bodies whose active composition is a multielement oxide.

The present invention further relates to a process of heterogeneously catalyzed gas phase reactions, for example gas phase partial oxidation of organic compounds, in which aforementioned shaped catalyst bodies are used as catalysts.

Examples of such heterogeneously catalyzed partial oxidation processes are the preparation of acrolein from propylene and the preparation of methacrylic acid from methacrolein, as described, for example, in WO 2005/030393 and in EP-A 467 144. Partial oxidation products of organic compounds are important intermediates. Acrolein is, for example, an important intermediate in the preparation of acrylic acid which is obtainable by heterogeneously catalyzed partial oxidation of acrolein. Acrylic acid is an important monomer which can be free-radically polymerized as such or in the form of its alkyl esters. The resulting polymers are suitable, inter alia, as superabsorbent materials or as adhesives. In a corresponding manner, methacrylic acid is also suitable as such or in the form of its alkyl esters for preparing free-radical polymers. A prominent position is assumed, for example, by the methyl ester of methacrylic acid, which finds use in particular for the preparation of polymethyl methacrylate which is used as synthetic glass.

Processes described at the outset for preparing shaped catalyst bodies whose active composition is a multimetal oxide are known, for example, in US 2005/0131253 A1. A shaping assistant (for example a lubricant) is added in the shaped catalyst body preparation, inter alia, in order to reduce the mechanical attrition on the shaping tools. Typically, the shaping assistant (for example lubricant) used is finely divided graphite. Its additional use also has an advantageous effect on the inner structure and the inner integrity both of the shaped catalyst precursor bodies and of the resulting shaped catalyst bodies. Since graphite is combustible as a carbon-comprising substance, the shaped catalyst precursor body comprising added finely divided graphite is treated thermally in a manner known per se, generally in such a way that the graphite does not ignite during the thermal treatment. This entails a certain degree of care, especially when the atmosphere in which the thermal treatment is effected comprises molecular oxygen (but the oxidizing effect may also result from the precursor composition itself). Since naturally occurring graphite is a mixture of graphite and mineral constituents which are capable of catalyzing the ignition of the graphite and may impair the catalyst performance, synthetic graphite whose ignition temperature depends substantially only upon its granularity is normally used. When natural graphite is used, with a given granularity and specific surface area, the ignition temperature is dependent, in a manner known per se, upon the type and amount of its mineral contents. The change to a new source of natural graphite would therefore generally be accompanied by complicated processes of adapting the preparation process. This is a further disadvantage of use of natural graphite as a lubricant in the relevant preparation of shaped catalyst bodies. When the graphite burns during the preparation thereof, those temperatures which are contemplated for the thermal treatment of the shaped catalyst precursor bodies are normally significantly exceeded, which generally causes a reduction of the catalyst performance in the gas phase reaction to be catalyzed heterogeneously. The reason for a further disadvantage of use of graphite as a shaping assistant is that the graphite remaining in the shaped catalyst body reductively impairs the multimetal oxide during the running time of the catalyst when it is utilized for a heterogeneously catalyzed gas phase reaction, especially a partial oxidation.

However, one advantage of use of finely divided graphite as a shaping assistant, for example as a lubricant, is that graphite remaining in the shaped catalyst body in the thermal treatment normally behaves inertly with regard to most heterogeneously catalyzed gas phase reactions, i.e. does not bring about any disruption. Typical graphite use amounts range from 0.1 to 20 or to 10% by weight, based on the mass of the shaped catalyst precursor body.

It was therefore an object of the present invention to provide an improved process for preparing shaped catalyst bodies with additional use of a shaping assistant, which firstly has the disadvantages of use of graphite in reduced form or no longer has them at all, but retains the advantages of such a use.

Accordingly, a process has been found for preparing shaped catalyst bodies whose active composition is a multielement oxide, in which a finely divided precursor mixture which comprises an added finely divided shaping assistant is shaped (compacted) to the desired geometry and the resulting shaped catalyst precursor bodies are treated thermally at elevated temperature to obtain the shaped catalyst bodies whose active composition is a multielement oxide, wherein the finely divided precursor mixture comprises added boron nitride as the shaping assistant.

According to the invention, the finely divided precursor mixture preferably comprises the boron nitride in finely divided form. Particularly advantageous boron nitrides (BN) for the process according to the invention are the finely divided boron nitrides from H. C. Starck, P.O. Box 2540, 38615 Goslar, Germany. Among these, favorable boron nitrides for the inventive use are in particular the following:
a) Boron Nitride Grade A 01 (Number PD-5006, Issue 0-07.99)

This is white, hexagonal powder. The accompanying HS number is: 28500030. The specific BET surface area is from 4.0 to 7.5 m²/g (in all subsequent cases too, areameter II by BET to DIN 66132). The tap density is from 0.2 to 0.5 g/cm³ (in all subsequent cases too, to ASTM B 527 (25 ml grad. cylinder)). The powder has a high degree of crystallinity. The contents of the boron nitride powder are as follows (in all subsequent cases too, % by weight based on the total mass):

| B: | from 42.5 to 43.5% | by weight, |
|---|---|---|
| O: | from 0.5 to 1.2% | by weight, |
| B₂O₃ (water-soluble): | ≦0.15% | by weight, |
| H₂O: | ≦0.15% | by weight and |
| C: | ≦0.10% | by weight. |

b) Boron Nitride Grade B50 (Number PD-5006, Issue 0-07.99)

This is white, hexagonal powder. The accompanying HS number is: 28500030. The specific BET surface area is from 4.0 to 6.5 m²/g. The tap density is from 0.2 to 0.5 g/cm³. The powder has a high degree of crystallinity. The contents of the boron nitride powder are as follows:

| B: | from 41.5 to 43.5% | by weight, |
|---|---|---|
| O: | ≦6.0% | by weight, |
| B₂O₃ (water-soluble): | ≦5.0% | by weight, |
| H₂O: | ≦0.7% | by weight and |
| C: | ≦0.2% | by weight. |

c) Boron Nitride Grade T15 (Number PD-5180, Issue 0-22.04.2003)

This is white, hexagonal powder. The accompanying HS number is: 28500020. The specific BET surface area is from 10 to 20 m²/g. The tap density is from 0.2 to 0.5 g/cm³. The powder has a high degree of crystallinity. The contents of the boron nitride powder are as follows:

| B: | from 42.5 to 43.5% | by weight, |
|---|---|---|
| O: | ≦1.0% | by weight, |
| B₂O₃ (water-soluble): | ≦0.3% | by weight, |
| H₂O: | ≦0.15% | by weight and |
| C: | ≦0.10% | by weight. |

d) Boron Nitride Grade B100 (Number PD-5002, Issue 0-07.99)

This is hexagonal, agglomerated, grayish powder. The accompanying HS number is: 28500030. The tap density is from 0.3 to 0.8 g/cm³. The contents of the boron nitride powder are as follows:

| B: | from 37.0 to 43.5% | by weight, |
|---|---|---|
| B₂O₃ (water-soluble): | ≦7.5% | by weight, |
| H₂O: | ≦1.0% | by weight and |
| C: | ≦6.0% | by weight. |

e) Boron Nitride Grade C (Number PD-5004, Issue 1-01.06.2001)

This is hexagonal, agglomerated, white powder. The accompanying HS number is: 28500030. The specific BET surface area is from 10 to 20 m²/g. The tap density is from 0.25 to 0.5 g/cm³. The contents of the boron nitride powder are as follows:

| | | |
|---|---|---|
| B: | ≧41.0% | by weight, |
| O: | ≦7.0% | by weight, |
| B₂O₃ (water-soluble): | from 5.0 to 8.0% | by weight, |
| H₂O: | ≦0.7% | by weight and |
| C: | ≦0.1% | by weight. |

Preference is generally given in accordance with the invention to boron nitrides which have no other constituents in addition to the constituents mentioned.

The aforementioned boron nitride powders are suitable especially for all inventive preparations of shaped catalyst bodies whose active composition is a multielement oxide, and to which reference is made in this document. This relates especially to the shaped catalyst bodies detailed by way of example.

Particularly advantageous for the process according to the invention is the use of boron nitrides whose content of water-soluble B₂O₃ is ≦5% by weight, preferably ≦3% by weight and more preferably ≦1% by weight or at best 0% by weight. This has a favorable effect on its oxidation resistance. Frequently, the content of water-soluble B₂O₃ on the same basis is ≧0.05% by weight.

Moreover, it is favorable for the process according to the invention when the boron nitride is present to an extent of at least 50% by weight, preferably to an extent of at least 75% by weight and most preferably exclusively in the hexagonal phase and has high crystallinity.

For the process according to the invention (especially for the preparation of all shaped catalyst bodies to which reference is made in this document, in particular all detailed by way of example), it is very particularly favorable to use Boron Nitride Grade A 01, number PD-5006, issue 0-07.99, which has been detailed above under a).

Appropriately in accordance with the invention, the particle diameter of the finely divided boron nitride to be used for the process according to the invention varies within the range from 1 μm to 50 μm, preferably in the range from 1 to 10 μm or to 5 μm (electron microscope or electron transmission microscope). Typically, in each case at least 50% (based in each case on the total number of particles), preferably at least 70% and more preferably at least 90% of the particle diameters vary within the aforementioned ranges. In general, the particles have a leaf-shaped form. In this document, the particle diameter always means the longest direct line joining two points on the particle surface.

In general, the finely divided precursor mixture in the process according to the invention comprises, based on its total weight, a total of from 0.1 to 10% by weight, or, if appropriate, up to 20% by weight, frequently from 0.3 to 8% by weight, in many cases from 0.5 to 6% by weight or from 0.5 to 5% by weight of finely divided shaping assistant. Normally, boron nitride will be the only shaping assistant (for example lubricant) added to the finely divided precursor mixture. In other words, based on its total weight (including the added boron nitride), from 0.1 to 10% by weight, or to 20% by weight, in many cases from 0.3 to 8% by weight, frequently from 0.5 to 6% by weight and usually from 0.5 to 5% by weight of finely divided boron nitride will be added to the finely divided precursor mixture in these cases. However, these proportions by weight also apply quite generally.

It is advantageous in accordance with the invention that boron nitride reacts with oxygen normally only at temperatures above 700° C. In neutral or reducing atmosphere and under reduced pressure, it is even stable up to temperatures above 1000° C. It is therefore comparatively simple in the process according to the invention to carry out the thermal treatment at temperatures which are below the aforementioned decomposition or reaction temperatures. In general, they are at least 30° C., or at least 50° C., or at least 75° C., or at least 100° C. below the aforementioned decomposition or reaction temperatures.

It is essential to the invention that the boron nitride remaining in the inventive shaped catalyst body in its preparation behaves substantially inertly with regard to the vast majority of the known heterogeneously catalyzed gas phase reactions and that the catalytic properties of the multielement oxide composition are substantially not impaired. It is also found to be advantageous that boron nitride is not reactive toward virtually all metals. It is also advantageous that the oxidation temperature of boron nitride, in contrast to graphite, is only insignificantly influenced by the environment present in the shaped catalyst precursor body.

For the process according to the invention, it is also advantageous that boron nitride, in contrast to graphite, does not lose its lubricant properties even at temperatures >400° C. This has an advantageous effect on the integrity within the shaped catalyst bodies. It is also found to be favorable for the process according to the invention that the bulk density (approx. 2.25 g/cm³ at 25° C., 1 atm) of boron nitride is comparatively low and the thermal conductivity is comparatively high. Also of particular significance for the process according to the invention is the low coefficient of thermal expansion of boron nitride (10⁻⁶/° C. in the temperature range from 20 to 1000° C.; cf. Chemical Economy & Engineering Review, January & February 1976 Vol. 8, No. 1,2 (No. 92), pages 29-34), which has a shape-preserving effect in the thermal treatment of the shaped catalyst precursor body. Owing to its excellent corrosion resistance, the boron nitride present in the shaped catalyst bodies is very substantially preserved even in the course of the later heterogeneously catalyzed gas phase reaction. The preparation of boron nitride is described, for example, in DE-A 24 61 821. Alpha-boron nitride is the hexagonal modification preferred in accordance with the invention (cf. also Radex-Rundschau, Schwetz-Reinmuth-Lipp: Refraktäre Borverbindungen [Refractory boron compounds], number 3, 1981, pages 568-585).

Boron nitrides appropriate for the process according to the invention have the following properties:

| | |
|---|---|
| particle diameter: | from 1 to 10 μm, preferably to 5 μm; |
| specific BET surface area: | from 5 to 20 m²/g; preferably to 15 m²/g; |
| bulk density: | from 0.2 to 0.6 g/cm³; |
| tap density: | from 0.3 to 0.7 g/cm³. |

In summary, the boron nitride to be used in accordance with the invention has a higher oxidation stability than graphite, and is simultaneously sufficiently chemically inert in the same way as graphite in order not to adversely affect the catalyst quality.

Accordingly, it is also possible to use the following hexagonal boron nitride powders, S1, S2 and SX from Elektroschmelzwerk Kempten GmbH, Kempten works, to carry out the process according to the invention.

These-powders are characterized by the following properties:

| | S1 | S2 | SX |
|---|---|---|---|
| Purity (B + N) | >98.5% by wt. | >98.5% by wt. | >90.0% by wt. |
| Nitrogen (N) | >54.5% by wt. | >54.5% by wt. | >50.0% by wt. |
| Total oxygen (O) | <1.5% by wt. | <1.5% by wt. | <7.0% by wt. |
| B₂O₃ | <0.1% by wt. | <0.1% by wt. | <7.0% by wt. |
| Carbon (C) | <0.1% by wt. | <0.1% by wt. | <0.1% by wt. |
| Metallic impurities | <0.2% by wt. | <0.2% by wt. | <0.2% by wt. |
| Particle size (diameter) | 3 μm | 5 μm | 3 μm |
| (primary particles) | | | |
| Specific surface area | 10 to 15 | 5 to 10 | 8 to 12 |
| (BET, m²/g) | | | |

Also particularly advantageous for the process according to the invention is the acid stability of the boron nitrides detailed in this document. This makes shaped catalyst bodies prepared in accordance with the invention especially suitable as catalysts for the preparation of α,β-ethylenically unsaturated carboxylic acids by heterogeneously catalyzed partial oxidation of suitable precursor compounds.

Advantageously in accordance with the invention, the finely divided precursor mixture will comprises exclusively boron nitride as a shaping assistant. It will be appreciated that the boron nitride may also be used in the process according to the invention together with other shaping assistants. Such other shaping assistants may, for example, be carbon black, stearic acid, starch, polyacrylic acid, mineral or vegetable oil, water, fine Teflon powder (for example powder from Aldrich 43093-5), boron trifluoride and/or graphite. When shaping assistant mixtures are used, the statements made in connection with the amounts of boron nitride added apply to the amount thereof added to the finely divided precursor mixture.

Advantageously in accordance with the invention, and adjusted to the individual type of active composition desired in each case, the shaped catalyst precursor bodies can be treated thermally at temperatures in the range from 150° C. to 650° C. Frequently, the thermal treatment of the shaped catalyst precursor bodies will be effected at temperatures in the range from 200° C. to 600° C. or from 250° C. to 550° C. or from 300° C. to 500° C. The duration of the thermal treatment can extend over a period of from a few hours up to several days. The thermal treatment can be effected under reduced pressure, under inert atmosphere (for example N₂, noble gases, etc.), under reducing atmosphere (for example H₂ or NH₃) or under oxidizing atmosphere. In general, oxidizing atmospheres will comprise molecular oxygen. Typical oxidizing atmospheres are mixtures of inert gas (N₂, noble gases, etc.) and molecular oxygen. Typically, the content of molecular oxygen will be at least 0.1% by volume, frequently at least 0.2% by volume, in many cases at least 0.5% by volume, often at least 1% by volume, or at least 10% by volume, or at least 20% by volume. It will be appreciated that the content of molecular oxygen in such mixtures may also be 30% by volume, or 40% by volume, or 50% by volume, or 70% by volume or more.

It will be appreciated that a possible atmosphere for the thermal treatment is also pure molecular oxygen. Frequently, the thermal treatment will be effected under air. Generally, the shaped catalyst precursor bodies can be treated thermally under stationary or under flowing gas atmosphere. The term atmosphere (or gas atmosphere) in which the thermal treatment is effected is to be understood in this document in such a way that it does not comprise gases being evolved from the shaped catalyst precursor bodies in the course of the thermal treatment owing to decomposition processes. It will be appreciated that the gas atmosphere in which the thermal treatment is effected may also consist exclusively or partly of these gases. In the course of the thermal treatment being effected in the process according to the invention, both the treatment temperature and the treatment atmosphere over the treatment time may be constant over time or else variable over time.

The particle diameters of the finely divided precursor mixture (excluding the added shaping assistant) will, when it is shaped to the desired geometry of the shaped catalyst precursor body, generally be within the range from 10 to 2000 μm. In many cases, aforementioned particle diameters will be within the range from 20 to 1800 μm, or from 30 to 1700 μm, or from 40 to 1600 μm, or from 50 to 1500 μm. Particularly frequently, these particle diameters will be from 100 to 1500 μm, or from 150 to 1500 μm (the term particle diameter here also means the longest direct line joining two points on the particle surface).

In general, the finely divided precursor mixture is shaped (compacted) to the geometry of the shaped catalyst precursor body by action of external forces (pressure) on the finely divided precursor mixture. The shaping apparatus to be employed and the shaping method to be employed are not subject to any restriction. The desired geometry of the shaped catalyst precursor body is likewise not subject to any restriction. In other words, the shaped catalyst precursor bodies may have a regular or irregular shape, preference generally being given to regularly shaped bodies.

Frequently, the shaped catalyst precursor bodies will have spherical geometry. The sphere diameter may be, for example, from 2 to 10 mm, or from 4 to 8 mm. The geometry of the shaped catalyst precursor body may also be a solid cylinder or hollow cylinder. In both cases, external diameter and length may be, for example, from 2 to 10 mm or from 4 to 8 mm. In the case of hollow cylinders, a wall thickness of from 1 to 3 mm is generally appropriate. It will be appreciated that useful shaped catalyst precursor geometries are also all of those geometries which are disclosed and recommended in WO 02/062737. In general, the geometry of the resulting shaped catalyst body deviates from the geometry of the shaped catalyst precursor body only insignificantly in the process according to the invention.

It should be emphasized at this point that processes particularly advantageous in accordance with the invention for preparing shaped catalyst bodies and hence particularly favorable shaped catalyst bodies result when, in the preparation processes disclosed in the documents WO 03/78310, DE-A 198 55 913, WO 02/24620, DE-A 199 22 113, US-A 2005/0131253, WO 02/062737 and WO 05/030393, at the places where finely divided graphite is additionally used, it is replaced by equal weights of finely divided boron nitride and all remaining preparation measures are retained unchanged. The resulting shaped catalyst bodies can then be used in an entirely corresponding manner to that described in the documents DE-A 199 22 113, DE-A 198 55 913, US-A 2005/0131253, WO 02/24620, WO 03/078310, WO 02/062737 and WO 05/030393 for the corresponding heterogeneously catalyzed gas phase reactions. They are advantageous especially when the graphite is replaced in each case by boron nitride Grade A 01 (Number PD-5006, Issue 0-07.99 from H. C. Starck).

The shaping can be effected in the process according to the invention, for example, by tableting or extruding. When this is done, the finely divided precursor mixture is typically used dry to the touch. However, it may comprise added substances which are liquid under standard conditions (25° C., 1 atm) in up to 10% of its total weight. However, the process according to the invention can also be employed when the finely divided precursor mixture no longer comprises any such liquid substances at all. It will be appreciated that the finely divided precursor mixture may also consist of solid solvates (for example hydrates) which have such liquid substances in chemically and/or physically bound form.

The shaping pressures employed in the process according to the invention will generally be from 50 kg/cm² to 5000 kg/cm². The shaping pressures are preferably from 200 to 3500 kg/cm², more preferably from 600 to 2500 kg/cm². The aforementioned is especially true when the shaping process employed is tableting. The basic features of tableting are described, for example, in “Die Tablette”, Handbuch der Entwicklung, Herstellung und Qualitätssicherung [“The tablet”, handbook of development, production and quality assurance], W. A. Ritschel and A. Bauer-Brandl, 2nd Edition, Editio Cantor Verlag Aulendorf, 2002, and are applicable in an entirely corresponding manner to an inventive tableting process.

Useful multielement oxide compositions in the process according to the invention are both active compositions which, in addition to oxygen, comprise both metals and nonmetals as elemental constituents. The multielement oxide active compositions are, though, frequently pure multimetal oxide active compositions.

Multielement oxide active compositions particularly favorable for employment of the process according to the invention, including accompanying precursor compositions, are, for example, those which are disclosed in the documents WO 2005/030393, EP-A 467 144, EP-A 1 060 792, DE-A 198 55 913, WO 03/078310, DE-A 199 22 113, WO 02/24620, WO 02/062737 and US-A 2005/0131253.

Finely divided precursor mixtures useable in accordance with the invention are obtainable in the simplest manner, for example by generating, from sources of the elemental constituents of the desired active composition, a finely divided, very intimate shapeable mixture having a composition corresponding to the stoichiometry of the desired active composition, to which shaping assistants and, if desired, reinforcing assistants may be added (or may be incorporated from the outset).

Useful sources of the elemental constituents of the desired active composition are in principle those compounds which are already oxides and/or those compounds which can be converted to oxides by heating, at least in the presence of gaseous molecular oxygen. In principle, the oxygen source may also be part of the precursor mixture, for example, in the form of a peroxide. The precursor mixture may also comprise added compounds such as NH₄OH, (NH₄)₂CO₃, NH₄NO₃, NH₄CHO₂, CH₃COOH, NH₄CH₃CO₂ and/or ammonium oxalate, which dissociate and/or can be decomposed in the thermal treatment as pore formers to give compounds which escape entirely in gaseous form.

The starting compounds (sources) can be mixed, preferably intimately, to prepare the finely divided shapeable precursor mixture in the process according to the invention in dry or in wet form. When it is done in dry form, the starting compounds are appropriately used in the form of finely divided powder (particle diameters appropriate in the range from 1 to or from 10 to 2000 μm, preferably from 20 to 1800 μm, more preferably from 30 to 1700 μm and most preferably from 40 to 1600 μm, or from 50 to 1500 μm or from 100 to 1500 μm, or from 150 to 1500 μm). Addition of the inventive shaping assistants and, if appropriate, addition of further shaping and/or reinforcing assistants may be followed by the shaping. Such reinforcing assistants may, for example, be microfibers of glass, asbestos, silicon carbide and/or potassium titanate. Quite generally, one starting compound may be the source of more than one elemental constituent in the process according to the invention.

However, preference is given in accordance with the invention to effecting the intimate mixing in wet form. Typically, the starting compounds are mixed with one another, for example, in the form of an aqueous solution and/or suspension. Particularly intimate shapeable mixtures are obtained when the starting materials are exclusively sources of the elemental constituents present in dissolved form. The solvent used is preferably water. Subsequently, the resulting solution or suspension is dried, the drying operation preferably being effected by spray-drying with exit temperatures of from 100 to 150° C.

The granularity of the resulting spray powder is typically from 20 to 50 μm. When water has been the basis of the liquid medium, the resulting spray powder will normally not comprise more than 20% of its weight, preferably not more than 15% of its weight and more preferably not more than 10% of its weight of water. These percentages generally also apply when other liquid solvents or suspension assistants are employed. After addition of the inventive shaping assistants and, if appropriate, further shaping and/or reinforcing assistants, the pulverulent mixture, as a finely divided precursor mixture, may be compacted (shaped) in accordance with the invention to give the desired shaped catalyst precursor body. The finely divided shaping and/or reinforcing assistants may also already have been added before the spray drying (partly or fully).

An only partial removal of the solvent or suspension medium may also be appropriate when its additional use as a shaping assistant is intended.

Instead of shaping the finely divided precursor mixture based directly on the spray powder, it is frequently appropriate first to carry out an intermediate compaction in order to coarsen the powder (generally to particle diameters of from 100 to 2000 μm, preferably from 150 to 1500 μm, more preferably from 400 to 1000 μm).

Even before the intermediate compaction, it is possible to add boron nitride to be used in accordance with the invention as a compacting assistant. Subsequently, the actual shaping is effected on the basis of the coarsened powder, for which it is possible if required again to add finely divided inventive boron nitride (and, if appropriate, further shaping and/or reinforcing assistants) beforehand.

It will be appreciated that the sources used of the elemental constituents may also be starting compounds which have themselves been obtained by thermal treatment of shaped precursor bodies, and are of multielement oxide nature. In particular, the starting compounds of the elemental constituents may be of multimetallic nature.

The process according to the invention is suitable especially for preparing shaped catalyst bodies whose active composition is a multielement oxide, within which the element Mo is the numerically (calculated in molar terms) most frequently occurring element. In particular, it is suitable for preparing shaped catalyst bodies whose active composition is a multielement oxide which comprises the elements Mo, Fe and Bi, or the elements Mo and V, or the elements Mo, V and P. The first shaped catalyst bodies in the above list are suitable in particular for heterogeneously catalyzed partial gas phase oxidations of propylene to acrolein. The second shaped catalyst bodies are suitable in particular for heterogeneously catalyzed partial gas phase oxidations of acrolein to acrylic acid and the latter shaped catalyst bodies in the above list are suitable in particular for heterogeneously catalyzed partial gas phase oxidations of methacrolein to methacrylic acid.

In particular, the present invention comprises a process for preparing annular shaped catalyst bodies (also known as unsupported catalysts because they do not have any inert support body to which the active composition has been applied) with curved and/or uncurved top surface of the rings, whose active composition (boron nitride present in the active composition is disregarded as always in this document, since it normally behaves chemically inertly and is not catalytically active) has a stoichiometry of the general formula I
Mo₁₂BiₐFe_{b}X¹_{c}X²_{d}X³ₑX⁴_{f}Oₙ (I),
where
X¹=nickel and/or cobalt,
X²=thallium, an alkali metal and/or an alkaline earth metal,
X³=zinc, phosphorus, arsenic, boron, antimony, tin, cerium, lead and/or tungsten,
X⁴=silicon, aluminum, titanium and/or zirconium,
a=from 0.2 to 5,
b=from 0.01 to 5,
c=from 0 to 10,
d=from 0 to 2,
e=from 0 to 8,
f=from 0 to 10 and
n=a number which is determined by the valency and frequency of the elements in I other than oxygen,
   or a stoichiometry of the general formula II
   [Y¹_{a′}Y²_{b′}O_{x′}]ₚ[Y³_{c′}Y⁴_{d′}Y⁵_{e′}Y⁶_{f′}Y⁷_{g′}Y²_{h′}O_{y′}]_{q} (II)
   where
Y¹=only bismuth or bismuth and at least one of the elements tellurium, antimony, tin and copper,
Y²=molybdenum, or tungsten, or molybdenum and tungsten,
Y³=an alkali metal, thallium and/or samarium,
Y⁴=an alkaline earth metal, nickel, cobalt, copper, manganese, zinc, tin, cadmium and/or mercury,
Y⁵=iron or iron and at least one of the elements vanadium, chromium and cerium,
Y⁶=phosphorus, arsenic, boron and/or antimony,
Y⁷=a rare earth metal, titanium, zirconium, niobium, tantalum, rhenium, ruthenium, rhodium, silver, gold, aluminum, gallium, indium, silicon, germanium, lead, thorium and/or uranium,
a′=from 0.01 to 8,
b′=from 0.1 to 30,
c′=from 0 to 4,
d′=from 0 to 20,
e′=from >0 to 20,
f′=from 0 to 6,
g′=from 0 to 15,
h′=from 8 to 16,
x′, y′=numbers which are determined by the valency and frequency of the elements in II other than oxygen and
p, q=numbers whose p/q ratio is from 0.1 to 10,
   and whose annular geometry, without taking into account any existing curvature of the top surface, has a length L of from 2 to 11 mm, an external diameter E of from 2 to 11 mm and a wall thickness W of from 0.75 mm to 1.75 mm.

In this process, a finely divided shapeable precursor mixture will be obtained from sources of the elemental constituents of the active composition and annular shaped unsupported catalyst precursor bodies whose top surfaces are curved and/or uncurved will be formed from this mixture after addition of inventive shaping assistant and, if appropriate, further shaping and/or reinforcing assistant, and these shaped bodies will be converted to the annular unsupported catalysts by thermal treatment at elevated temperature.

The present invention also relates to the use of the annular unsupported catalysts obtainable by the process according to the invention as catalysts with increased activity and selectivity for the catalytic partial oxidation of propene to acrolein in the gas phase, and also of isobutene or tert-butanol or its methyl ether to methacrolein.

The aforementioned process for preparing annular shaped catalyst bodies is particularly advantageous when the finely divided precursor mixture is shaped (compacted) in such a way that the side crushing strength of the resulting annular shaped unsupported catalyst precursor bodies is ≧10 and ≦40 N, better ≧10 and ≦35 N, even better ≧12 and ≦23 N. The side crushing strength of the resulting annular shaped unsupported catalyst precursor bodies is ≧13 N and ≦22 N, or ≧14 N and ≦21 N. Most preferably, the side crushing strength of the resulting annular shaped unsupported catalyst precursor bodies is ≧15 N and ≦20 N.

Moreover, for these catalyst types, the granularity (the particle diameter) of the finely divided precursor mixture (excluding the assistants to be added) is advantageously from 200 μm to 1500 μm, more advantageously from 400 μm to 1000 μm. Favorably, at least 80% by weight, better at least 90% by weight and more advantageously at least 95 or 98 or more % by weight of the finely divided precursor mixture is within this granulation range. In this document, side crushing strength is understood to mean the crushing strength when the annular shaped unsupported catalyst precursor body is compressed at right angles to the cylindrical shell (i.e. parallel to the surface of the ring orifice). All side crushing strengths in this document relate to a determination by means of a Z 2.5/TS15 material testing machine from Zwick GmbH & Co (D-89079 Ulm). This material testing machine is designed for quasistatic stress having a single-impetus, stationary, dynamic or varying profile. It is suitable for tensile, compressive and bending tests. The installed KAF-TC force transducer from A.S.T. (D-01307 Dresden) with the manufacturer number 03-2038 was calibrated in accordance with DIN EN ISO 7500-1 and was usable for the 1-500 N measurement range (relatively measurement uncertainty: ±0.2%).

The measurements were carried out with the following parameters:

Initial force: 0.5 N.

Rate of initial force: 10 mm/min.

Testing rate: 1.6 mm/min.

The upper die was initially lowered slowly down to just above the surface of the cylindrical shell of the annular shaped unsupported catalyst precursor body. The upper die was then stopped, in order subsequently to be lowered at the distinctly slower testing rate with the minimum initial force required for further lowering.

The initial force at which the shaped unsupported catalyst precursor body exhibits crack formation is the side crushing strength (SCS).

Unsupported catalyst ring geometries which are particularly advantageous in accordance with the invention additionally fulfill the condition L/E=from 0.3 to 0.7. Particular preference is given to L/E being from 0.4 to 0.6.

It is also advantageous for the relevant unsupported catalyst rings when the I/E ratio (where I is the internal diameter of the unsupported catalyst ring geometry) is from 0.5 to 0.8, preferably from 0.6 to 0.7.

Particularly advantageous unsupported catalyst ring geometries are those which simultaneously have one of the advantageous L/E ratios and one of the advantageous I/E ratios. Such possible combinations are, for example, L/E=from 0.3 to 0.7 and I/E=from 0.5 to 0.8 or from 0.6 to 0.7. Alternatively, L/E may be from 0.4 to 0.6 and I/E simultaneously from 0.5 to 0.8 or from 0.6 to 0.7.

It is also preferred for the relevant unsupported catalyst rings when L is from 2 to 6 mm and more preferred when L is from 2 to 4 mm.

It is also advantageous when E is from 4 to 8 mm, preferably from 5 to 7 mm.

The wall thickness of the relevant unsupported catalyst ring geometries obtainable in accordance with the invention is advantageously from 1 to 1.5 mm.

In other words, favorable said unsupported catalyst ring geometries are, for example, those where L=from 2 to 6 mm and E=from 4 to 8 mm or from 5 to 7 mm. Alternatively, L may be from 2 to 4 mm and E simultaneously from 4 to 8 mm or from 5 to 7 mm. In all the aforementioned cases, the wall thickness W may be from 0.75 to 1.75 mm or from 1 to 1.5 mm.

Among the aforementioned favorable unsupported catalyst geometries, particular preference is given to those for which the aforementioned L/E and I/E combinations are simultaneously fulfilled.

Possible relevant unsupported catalyst ring geometries are thus (E×L×I) 5 mm×3 mm×2 mm, or 5 mm×3 mm×3 mm, or 5.5 mm×3 mm×3.5 mm, or 6 mm×3 mm×4 mm, or 6.5 mm×3 mm×4.5 mm, or 7 mm×3 mm×5 mm.

The top surfaces of the rings obtained as described may also either both be, or only one may be, curved as described in EP-A 184790, and, for example, in such a way that the radius of the curvature is preferably from 0.4 to 5 times the external diameter E. Preference is given in accordance with the invention to both top surfaces being uncurved.

All of these unsupported catalyst ring geometries are suitable, for example, both for catalytic partial oxidation in the gas phase of propene to acrolein and for the catalytic partial oxidation in the gas phase of isobutene or tert-butanol or the methyl ether of tert-butanol to methacrolein.

Regarding the active compositions of the stoichiometry of the general formula I, the stoichiometric coefficient b is preferably from 2 to 4, the stoichiometric coefficient c is preferably from 3 to 10, the stoichiometric coefficient d is preferably from 0.02 to 2, the stoichiometric coefficient e is preferably from 0 to 5 and the stoichiometric coefficient a is preferably from 0.4 to 2. The stoichiometric coefficient f is advantageously from 0.5 or 1 to 10. Particular preference is given to the aforementioned stoichiometric coefficients simultaneously being within the preferred ranges mentioned.

In addition, X¹ is preferably cobalt, X² is preferably K, Cs and/or Sr, more preferably K, X³ is preferably zinc and/or phosphorus and X⁴ is preferably Si. Particular preference is given to the variables X¹ to X⁴ simultaneously having the aforementioned definitions.

Particular preference is given to all stoichiometric coefficients a to f and all variables X¹ to X⁴ simultaneously having their aforementioned advantageous definitions.

Within the stoichiometries of the general formula II, preference is given to those which correspond to the general formula III
[Bi_{a″}Z²_{b″}O_{x″}]_{p″}[Z²₁₂Z³_{c″}Z⁴_{d″}Fe_{e″}Z⁵_{f″}Z⁶_{g″}Z⁷_{h″}O_{y″}]_{q″} (III),
where
Z²=molybdenum, or tungsten, or molybdenum and tungsten,
Z³=nickel and/or cobalt, preferably Ni,
Z⁴=thallium, an alkali metal and/or an alkaline earth metal, preferably K, Cs and/or Sr,
Z⁵=phosphorus, arsenic, boron, antimony, tin, cerium and/or Bi,
Z⁶=silicon, aluminum, titanium and/or zirconium, preferably Si,
Z⁷=copper, silver and/or gold,
a″=from 0.1 to 1,
b″=from 0.2 to 2,
c″=from 3 to 10,
d″=from 0.02 to 2,
e″=from 0.01 to 5, preferably 0.1 to 3,
f″=from 0 to 5,
g″=from 0 to 10, preferably from >0 to 10, more preferably from 0.2 to 10 and most preferably from 0.4 to 3,
h″=from 0 to 1,
x″, y″=numbers which are determined by the valency and frequency of the elements in III other than oxygen and
p″, q″=numbers whose p″/q″ ratio is from 0.1 to 5, preferably from 0.5 to 2.

In addition, preference is given to active compositions of the stoichiometry II which contain three-dimensional regions of the chemical composition Y¹_{a′}Y²_{b′}O_{x′} which are delimited from their local environment as a consequence of their different composition from their local environment and whose longest diameter (longest line passing through the center of the region and connecting two points on the surface (interface) of the region) is from 1 nm to 100 μm, frequently from 10 nm to 500 nm or from 1 μm to 50 or 25 μm.

Particularly advantageous active compositions of the stoichiometry II are those in which Y¹ is only bismuth.

Within the active compositions of the stoichiometry III, preference is given in accordance with the invention to those in which Z²_{b′}=(tungsten)_{b′} and Z²₁₂=(molybdenum)₁₂.

In addition, for the annular unsupported catalysts discussed, preference is given to active compositions of the stoichiometry III which contain three-dimensional regions of the chemical composition Bi_{a″}Z²_{b″}O_{x″} which are delimited from their local environment as a consequence of their different composition than their local environment and whose longest diameter (longest line passing through the center of the region and connecting two points on the surface (interface) of the region) is from 1 nm to 100 μm, frequently from 10 nm to 500 nm or from 1 μm to 50 or 25 μm.

In addition, it is advantageous when at least 25 mol %, (preferably at least 50 mol % and more preferably at least 100 mol %) of the total [Y¹_{a′}Y²_{b′}O_{x′}]ₚ ([Bi_{a″}Z²_{b″}O_{x″}]_{p″}) fraction of the active compositions of the stoichiometry II (active compositions of the stoichiometry III) obtainable in accordance with the invention in the active compositions of the stoichiometry II (active compositions of the stoichiometry III) is in the form of three-dimensional regions of the chemical composition Y¹_{a′}Y²_{b′}O_{x′} ([Bi_{a″}Z²_{b″}O_{x″}]) which are delimited from their local environment as a consequence of their different chemical composition than their local environment and whose longest diameter is in the range from 1 nm to 100 μm.

Useful shaping assistants (lubricants) for the process according to the invention for preparing the relevant annular shaped catalyst bodies, in addition to boron nitride, are carbon black, stearic acid, starch, polyacrylic acid, mineral or vegetable oil, water, boron trifluoride and/or graphite. Glycerol and cellulose ether may also be used as further lubricants. Preference is given in accordance with the invention to adding exclusively boron nitride as a shaping assistant. Based on the composition to be shaped to the shaped unsupported catalyst precursor body, generally ≦10% by weight, usually ≦5% by weight, in many cases ≦3% by weight, often ≦2% by weight of boron nitride is added. Typically, the aforementioned added amount is ≧0.5% by weight. Boron nitride added with preference is Boron Nitride Grade A 01, Number PD-5006, Issue 0-07.99 from H. C. Starck.

It is also possible to add finely divided reinforcing agents such as microfibers of glass, asbestos, silicon carbide or potassium titanate. The shaping to the annular shaped unsupported catalyst precursor body may be carried out, for example, by means of a tableting machine, an extrusion reshaping machine or the like.

The relevant annular shaped unsupported catalyst precursor body is treated thermally generally at temperatures which exceed 350° C. Normally, the temperature in the course of the thermal treatment will not exceed 650° C. Advantageously in accordance with the invention, the temperature in the course of the thermal treatment will not exceed 600° C., preferably 550° C. and more preferably 500° C. In addition, the temperature in the course of the thermal treatment of the annular shaped unsupported catalyst precursor body will preferably exceed 380° C., advantageously 400° C., particularly advantageously 420° C. and most preferably 440° C. The thermal treatment may also be subdivided into a plurality of sections within its duration. For example, a thermal treatment may initially be carried out at a temperature of from 150 to 350° C., preferably from 220 to 280° C., and be followed by a thermal treatment at a temperature of from 400 to 600° C., preferably from 430 to 550° C.

Normally, the thermal treatment of the annular shaped unsupported catalyst precursor body takes several hours (usually more than 5 h). Frequently, the overall duration of the thermal treatment extends for more than 10 h. Usually, treatment durations of 45 h or 25 h are not exceeded in the course of the thermal treatment of the annular shaped unsupported catalyst precursor body. Often, the overall treatment time is below 20 h. Advantageously in accordance with the invention, 500° C. (460° C.) are not exceeded in the course of the thermal treatment of the relevant annular shaped unsupported catalyst precursor body, and the treatment time within the temperature window of ≧400° C. (≧440° C.) extends to from 5 to 20 h.

The thermal treatment (and also the decomposition phase addressed hereinbelow) of the annular shaped unsupported catalyst precursor bodies may be effected either under inert gas or under an oxidative atmosphere, for example air (mixture of inert gas and oxygen) or else under a reducing atmosphere (for example mixture of inert gas, NH₃, CO and/or H₂ or methane, acrolein, methacrolein). It will be appreciated that the thermal treatment may also be performed under reduced pressure.

In principle, the thermal treatment of the relevant annular shaped unsupported catalyst precursor bodies may be carried out in highly differing furnace types, for example heatable forced-air chambers, tray furnaces, rotary tube furnaces, belt calciners or shaft furnaces. Preference is given to effecting the thermal treatment of the annular shaped unsupported catalyst precursor bodies in a belt calcining apparatus as recommended by DE-A 10046957 and WO 02/24620.

The thermal treatment of the relevant annular shaped unsupported catalyst precursor bodies below 350° C. generally follows the thermal treatment of the sources of the elemental constituents of the desired annular unsupported catalyst present in the shaped unsupported catalyst precursor bodies. Frequently, this decomposition phase proceeds in the course of the heating at temperatures of ≧350° C.

The annular shaped unsupported catalyst precursor bodies of desired annular unsupported catalysts, whose active composition has a stoichiometry of the general formula I, or the general formula II, or the general formula II, may be prepared by generating, from sources of the elemental constituents of the active composition of the desired annular unsupported catalyst, a (very intimate) finely divided shapeable mixture having a composition corresponding to the stoichiometry of the desired active composition and, optionally after adding shaping and, if appropriate, reinforcing assistants (including those in accordance with the invention), forming from this an annular unsupported shaped catalyst precursor body (having curved and/or uncurved top surfaces) whose side crushing strength is ≧12 N and ≦23 N. The geometry of the annular shaped unsupported catalyst precursor body will correspond substantially to that of the desired annular unsupported catalyst.

Useful sources for the elemental constituents of the desired active composition are those compounds which are already oxides and/or those compounds which can be converted to oxides by heating, at least in the presence of molecular oxygen.

In addition to the oxides, useful such starting compounds are in particular halides, nitrates, formates, oxalates, citrates, acetates, carbonates, amine complexes, ammonium salts and/or hydroxides (compounds such as NH₄OH, (NH₄)₂CO₃, NH₄NO₃, NH₄CHO₂, CH₃COOH, NH₄CH₃CO₂ and/or ammonium oxalate which decompose and/or may be decomposed in the course of thermal treatment to give compounds which escape fully in gaseous form may additionally be incorporated into the finely divided shapeable mixture (preferably a dry mixture)).

The preferably intimate mixing of the starting compounds (sources) to prepare the finely divided shapeable mixture in the process according to the invention may be effected in dry or in wet form. When it is effected in dry form, the starting compounds are appropriately used as a finely divided powder (the particle size should advantageously be ≦100 μm, preferably ≦50 μm; in general the number-average largest particle diameter will be ≧1 μm or ≧10 μm). After addition of shaping and, if appropriate, reinforcing assistants (including those in accordance with the invention), the shaping to the annular shaped unsupported catalyst precursor body may subsequently be effected.

However, preference is given to effecting the intimate mixing in wet form. Typically, the starting compounds are mixed together in the form of an aqueous solution and/or suspension. Particularly intimate shapeable mixtures are obtained when the starting materials are exclusively sources of the elemental constituents present in dissolved form. The solvent used is preferably water. Subsequently, the resulting solution or suspension is dried, and the drying process is preferably effected by spray drying with exit temperatures of from 100 to 150° C. The particle size of the resulting spray powder is typically from 20 to 50 μm.

The spray powder may then be compressed (shaped) after addition of shaping and, if appropriate, reinforcing assistants (including those in accordance with the invention) to give the annular shaped unsupported catalyst precursor bodies. However, the finely divided shaping and if appropriate, reinforcing assistants may also be (partly or fully) added in advance of the spray drying. It is also possible in the course of the drying to only partly remove the solvent or suspension agent if the intention is to use it as a shaping assistant.

Instead of shaping the spray powder, optionally after adding shaping and, if appropriate, reinforcing assistants (including those in accordance with the invention), directly to the annular shaped unsupported catalyst precursor bodies (having curved and/or uncurved top surface of the rings), it is frequently appropriate to initially carry out an intermediate compaction in order to coarsen the powder (generally to a particle size of from 400 μm to 1 mm). Subsequently, the actual ring shaping is effected with the coarsened powder, and finely divided lubricant according to the invention may again be added beforehand if required.

Such an intermediate compaction for the purpose of particle coarsening may be effected, for example, by means of a compactor from Hosokawa Bepex GmbH (D-74211 Leingarten), of the K 200/100 compactor type. The hardness of the intermediate compactate is frequently already in the region of 10 N. Useful for the ring shaping to the shaped unsupported catalyst precursor body is, for example, a Kilian rotary tableting press (from Kilian in D-50735 Cologne) of the RX 73 or S 100 type. Alternatively, a tableting press from Korsch (D-13509 Berlin) of the PH 800-65 type may be used.

Especially for preparing active compositions of the stoichiometry of the general formula II or III, it is advantageous to preform a mixed oxide Y¹_{a′}Y²_{b′}O_{x′} or Bi_{a″}Z²_{b″}O_{x″} as the source of the elements Y¹, Y² and Bi, Z² respectively in the absence of the remaining constituents of the active compositions of the stoichiometry of the general formula II or III and thus, after its preformation, as already described, to generate a finely divided shapeable mixture using sources of the remaining constituents of the active compositions of the stoichiometry of the general formula II or III, in order to shape therefrom, after adding shaping and, if appropriate, reinforcing assistants (including those in accordance with the invention), the annular shaped unsupported catalyst precursor bodies.

In such a procedure, care has to be taken merely that, in the case that the preparation of the finely divided shapeable mixture is effected in wet form (in suspension), the preformed mixed oxides Y¹_{a′}Y²_{b′}O_{x′} or Bi_{a″}Z²_{b″}O_{x″} do not go into solution to a significant extent.

A preparation method as described above is described in detail in the documents DE-A 4407020, EP-A 835, EP-A 575897 and DE-C 3338380.

For example, water-soluble salts of Y¹ such as nitrates, carbonates, hydroxides or acetates may be mixed in water with Y² acids or their ammonium salts, the mixture dried (preferably spray-dried) and the dried composition subsequently thermally treated. The thermally treated composition is subsequently appropriately comminuted (for example in a ball mill or by jet milling) and, from the powder which generally consists of substantially spherical particles and is obtainable in this way, the particle class having a largest particle diameter lying within the largest diameter range desired for the active composition of the stoichiometry of the general formula II or III is separated by classification to be carried out in a manner known per se (for example wet or dry sieving) and is preferably mixed with, based on the mass of this separated particle class, from 0.1 to 3% by weight of finely divided SiO₂ (the number-average largest particle diameter of the typically substantially spherical SiO₂ particles is appropriately from 10 to 50 nm), thus producing a starting composition 1. The thermal treatment is appropriately effected at temperatures of from 400 to 900° C., preferably from 600 to 900° C. The latter is especially true when the preformed mixed oxide is one of the stoichiometry BiZ²O₆, Bi₂Z²₂O₉ and/or Bi₂Z²₃O₁₂, among which Bi₂Z²₂O₉ is preferred, especially when Z²=tungsten.

Typically, the thermal treatment is effected in an airstream (for example in a rotary tube furnace as described in DE-A 10325487). The duration of the thermal treatment generally extends to a few hours.

The remaining constituents of the desired active composition of the general formula II or III are normally used to prepare, starting from sources which are suitable in a manner known per se (cf. EP-A 835 and DE-C 3338380 and also DE-A 4407020), in an inventively appropriate manner, for example, a very intimate, preferably finely divided dry mixture (for example combining water-soluble salts such as halides, nitrates, acetates, carbonates or hydroxides in an aqueous solution and subsequently, for example, spray-drying the aqueous solution, or suspending water-insoluble salts, for example oxides, in aqueous medium and subsequently, for example, spray-drying the suspension) which is referred to here as starting composition 2. It is essential only that the constituents of the starting composition 2 are either already oxides or compounds which can be converted to oxides by heating, in the absence or presence of oxygen. Subsequently, the starting composition 1 and the starting composition 2 are mixed in the desired ratio in the inventive manner, i.e. after adding shaping and, if appropriate, reinforcing assistants (including those in accordance with the invention), to give the mixture which can be shaped to the annular shaped unsupported catalyst precursor body. The shaping may, as already described, appropriately from an application point of view, be effected by an intermediate compaction stage.

In a less preferred embodiment, the preformed mixed oxide Y¹_{a′}Y²_{b′}O_{x′} or Bi_{a″}Z²_{b″}O_{x″} may also be intimately mixed with sources of the remaining constituents of the desired active composition in liquid, preferably aqueous, medium. This mixture is subsequently, for example, dried to give an intimate dry mixture and then, as already described, shaped and thermally treated. The sources of the remaining constituents may be dissolved and/or suspended in this liquid medium, whereas the preformed mixed oxide should be substantially insoluble, i.e. has to be suspended, in this liquid medium.

The preformed mixed oxide particles are present having a substantially unchanged longitudinal dimension established by the classification in the finished annular unsupported catalyst.

The specific surface area of mixed oxides Y¹_{a′}Y²_{b′}O_{x′} or Bi_{a″}Z²_{b″}O_{x″} preformed in this way is preferably from 0.2 to 2 m²/g, more preferably from 0.5 to 1.2 m²/g. In addition, the total pore volume of mixed oxides preformed in this way advantageously results predominantly from micropores.

All data in this document on determinations of specific surface areas or on micropore volumes relate, unless stated otherwise, to determinations to DIN 66131 (determination of the specific surface area of solids by gas adsorption (N₂) according to Brunauer-Emmet-Teller (BET)).

All data in this document on determinations of total pore volumes and also of diameter distributions on these total pore volumes relate, unless stated otherwise, to determinations by the mercury porosimetry method employing the Auto Pore 9220 instrument from Micromeritics GmbH, 4040 Neuss, DE (bandwidth from 30 Å to 0.3 mm).

Advantageous relevant annular unsupported catalysts are those whose specific surface area S is from 5 to 20 or 15 m²/g, frequently from 5 to 10 m²/g. The total pore volume of such annular unsupported catalysts is advantageously in the range from 0.1 to 1 or 0.8 cm³/g, frequently in the range from 0.2 to 0.4 cm³/g.

In contrast to the teaching of WO 03/039744 and to the teaching of EP-A 279374, the different pore diameters in annular unsupported catalysts obtained as described advantageously contribute to the total pore volume as follows:

pores having a diameter in the range from ≦0.03 μm: ≦5% by volume;

pores having a diameter in the range from ≧0.03 to ≦0.1 μm: ≦25% by volume;

pores having a diameter in the range from ≧0.1 to ≦1 μm:≧70% by volume and

pores having a diameter in the range from ≧1 to ≦10 μm: ≦10% by volume.

In other words, in contrast to the teaching of EP-A 279374, the proportion of the pores having a diameter of ≧1 μm generally plays only a minor role in annular unsupported catalysts obtained as described.

In addition, the proportion of pores having a diameter in the range from ≧0.03 to ≦0.1 μm in annular unsupported catalysts obtained as described generally plays a relatively minor role.

Particularly advantageously, the proportion of the different pore diameters in the total pore volume in annular unsupported catalysts obtained as described has the following distribution:

pores having a diameter in the range from ≦0.03 μm:≧0 and ≦5% by volume, preferably ≦3% by volume;

pores having a diameter in the range from ≧0.03 to ≦0.1 μm:≧3 or ≧5 and ≦20 or ≦15% by volume;

pores having a diameter in the range from ≧0.1 to ≦1 μm:≧75 or ≧80 and ≦95 or ≦90% by volume;

pores having a diameter in the range from ≧1 μm to ≦10 μm:≧0 and ≦5% by volume, preferably ≦3% by volume.

In other words, for annular unsupported catalysts obtained as described, the pore diameter range from >0.1 to <1 μm plays the decisive role with regard to their performance when they are used as catalysts for the partial oxidation of propene to acrolein, or isobutene or tert-butanol or the methyl ether of tert-butanol to methacrolein.

In contrast, pores in the pore diameter range from 0.01 to 0.1 μm promote the partial oxidation of propene to acrylic acid. This is advantageous when the active composition is used in the first stage of a two-stage partial oxidation of propene to acrylic acid, since acrylic acid formed in the first stage is substantially preserved in the second stage.

The aforementioned is also additionally confirmed by particularly advantageous annular unsupported catalysts obtained as described not only fulfilling the aforementioned conditions with regard to specific surface area S, total pore volume V and pore diameter distribution, but also additionally the pore diameter dmax making the largest percentage contribution to the total pore volume V lying within the diameter range from 0.3 to 0.8 μm, particularly advantageously in the diameter range from 0.4 to 0.7 μm and very particularly advantageously in the diameter range from 0.5 to 0.6 μm.

It is surprising that with increasing side crushing strength of the annular shaped unsupported catalyst precursor body, the pore diameter in the resulting unsupported catalyst ring is generally shifted to larger values.

This is surprising in that the side crushing strength of the resulting annular unsupported catalyst is simultaneously shifted to higher values. Surprisingly, the side crushing strength of the annular unsupported catalyst resulting as described is generally less than the side crushing strength of the corresponding annular shaped unsupported catalyst precursor body.

Typically, the side crushing strengths of annular unsupported catalysts obtainable as described are from 5 to 13 N, frequently from 8 to 11 N. These side crushing strengths of annular unsupported catalysts obtainable as described are normally also present when the remaining physical properties described as advantageous (for example S, V and pore diameter distribution) of annular unsupported catalysts obtainable as described are present.

As already mentioned, the annular unsupported catalysts obtainable as described are especially suitable as catalysts for the partial oxidation of propene to acrolein or of isobutene and/or tert-butanol to methacrolein. The partial oxidation may be carried out as described, for example, in the documents WO 00/53557, WO 00/53558, DE-A 199 10 506, EP-A 1 106 598, WO 01/36364, DE-A 199 27 624, DE-A 199 48 248, DE-A 199 48 523, DE-A 199 48 241, EP-A 700 714, DE-A 10313213, DE-A 103 13 209, DE-A 102 32 748, DE-A 103 13 208, WO 03/039744. EP-A 279 374, DE-A 33 38 380, DE-A 33 00 044, EP-A 575 897, DE-A 10 2004 003 212, DE-A 10 2005 013 039, DE-A 10 2005 009 891, DE-A 10 2005 010111, DE-A 10 2005 009 885 and DE-A 44 07 020, and the catalyst charge may comprise, for example, only annular unsupported catalysts obtainable as described or, for example, annular unsupported catalysts diluted with inert shaped bodies. In the latter case, the catalyst charge, advantageously, is generally configured in such a way that its volume-specific activity increases continuously, sharply and/or in stages in the flow direction of the reaction gas mixture.

The ring geometries of the unsupported catalysts obtainable as described emphasized individually in this document are found to be especially advantageous when the hourly space velocity on the catalyst charge of propene, isobutene and/or tert-butanol (or its methyl ether) present in the starting reaction gas mixture is ≧130 l (STP)/l of catalyst charge·h (upstream and/or downstream beds of pure inert material are not regarded as belonging to the catalyst charge in space velocity calculations). This is especially true when the other physical properties, described as advantageous in this document, of annular unsupported catalysts obtainable as described are also present.

However, this advantageous behavior of annular unsupported catalysts obtainable as described, in particular the aforementioned, is also present when the aforementioned hourly space velocity on the catalyst charge is ≧140 l (STP)/l·h, or ≧150 l (STP)/l·h, or ≧160 l (STP)/l·h. Normally, the aforementioned hourly space velocity on the catalyst charge will be ≦600 l (STP)/l·h, frequently ≦500 l (STP)/l·h, in many cases ≦400 l (STP)/l·h or ≦350 l (STP)/l·h. Hourly space velocities in the range from 160 l (STP)/l·h to 300 or 250 or 200 l (STP)/l·h are particularly typical.

It will be appreciated that the annular unsupported catalysts obtainable as described may also be used as catalysts for the partial oxidation of propene to acrolein or of isobutene and/or tert-butanol (or its methyl ether) to methacrolein at hourly space velocities on the catalyst charge of the starting compound to be partially oxidized of <130 l (STP)/l·h, or ≦120 l (STP)/1-h, or ≦110 l (STP)/l·h. However, this hourly space velocity will generally be at values of ≧60 l (STP)/l·h, or ≧70 l (STP)/l·h, or ≧80 l (STP)/l·h.

In principle, the hourly space velocity on the catalyst charge of the starting compound to be partially oxidized (propene, isobutene and/or tert-butanol (or its methyl ether)) may be adjusted using two adjusting screws:
a) the hourly space velocity on the catalyst charge of starting reaction gas mixture; and/or
b) the content in the starting reaction gas mixture of the starting compound to be partially oxidized.

The annular unsupported catalysts obtainable in accordance with the invention are also especially suitable when, at hourly space velocities on the catalyst charge of the organic compound to be partially oxidized which are above 130 l (STP)/l·h, the hourly space velocity is adjusted in particular using the aforementioned adjusting screw a).

The propene fraction (isobutene fraction or tert-butanol fraction (or its methyl ether fraction)) in the starting reaction gas mixture will generally be (i.e. essentially irrespective of the hourly space velocity) from 4 to 20% by volume, frequently from 5 to 15% by volume, or from 5 to 12% by volume, or from 5 to 8% by volume (based in each case on the total volume).

Frequently, the process of the partial oxidation catalyzed by the annular unsupported catalysts obtainable as described will be carried out (essentially irrespective of the hourly space velocity) at an (organic) compound to be partially oxidized (e.g. propene):oxygen:inert gases (including steam) volume ratio in the starting reaction gas mixture of from 1:(1.0 to 3.0):(5 to 25), preferably 1:(1.5 to 2.3):(10 to 15).

Inert gases refer to those gases of which at least 95 mol %, preferably at least 98 mol %, remains chemically unchanged in the course of the partial oxidation.

In the above-described starting reaction gas mixtures, the inert gas may consist of ≧20% by volume, or ≧30% by volume, or ≧40% by volume, or ≧50% by volume, or ≧60% by volume, or ≧70% by volume or ≧80% by volume, or ≧90% by volume or ≧95% by volume, of molecular nitrogen.

However, when the hourly space velocities on the catalyst charge of the organic compound to be partially oxidized are (250 l (STP)/l·h, it is recommended to use inert diluent gases such as propane, ethane, methane, pentane, butane, CO2, CO, steam and/or noble gases for the starting reaction gas mixture. Generally, these inert gases and their mixtures may also be used even at lower inventive hourly space velocities on the catalyst charge of the organic compound to be partially oxidized. Cycle gas may also be used as a diluent gas. Cycle gas refers to the residual gas which remains when the target compound is substantially selectively removed from the product gas mixture of the partial oxidation. It has to be taken into account that the partial oxidations to acrolein or methacrolein using the annular unsupported catalysts obtainable as described may only be the first stage of a two-stage partial oxidation to acrylic acid or methacrylic acid as the actual target compounds, so that the cycle gas is then not usually formed until after the second stage. In such a two-stage partial oxidation, the product gas mixture of the first stage is generally fed as such, optionally after cooling and/or secondary oxygen addition, to the second partial oxidation stage.

In the partial oxidation of propene to acrolein using the annular unsupported catalysts obtainable as described, a typical composition of the starting reaction gas mixture (irrespective of the hourly space velocity selected) may comprise, for example, the following components:
from 6 to 6.5% by volume of propene,
from 3 to 3.5% by volume of H2O,
from 0.3 to 0.5% by volume of CO,
from 0.8 to 1.2% by volume of CO₂,
from 0.025 to 0.04% by volume of acrolein,
from 10.4 to 10.7% by volume of O₂ and,
as the remainder ad 100%, molecular nitrogen,

or:
5.4% by volume of propene,
10.5% by volume of oxygen,
1.2% by volume of COx,
81.3% by volume of N2 and
1.6% by volume of H2O.

However, the starting reaction gas mixture may also have the following composition:
from 6 to 15% by volume of propene,
from 4 to 30% by volume (frequently from 6 to 15% by volume) of water,
from ≧0 to 10% by volume (preferably from ≧0 to 5% by volume) of constituents other than propene, water, oxygen and nitrogen, and sufficient molecular oxygen that the molar ratio of molecular oxygen present to molecular propene present is from 1.5 to 2.5, and, as the remainder up to 100% by volume of the total amount, molecular nitrogen.

Another possible starting reaction gas mixture composition may comprise:
6.0% by volume of propene,
60% by volume of air and
34% by volume of H2O.

Alternatively, starting reaction gas mixtures of the composition according to Example 1 of EP-A 990 636, or according to Example 2 of EP-A 990 636, or according to Example 3 of EP-A 1 106 598, or according to Example 26 of EP-A 1 106 598, or according to Example 53 of EP-A 1 106 598, may also be used.

The annular catalysts obtainable as described are also suitable for the processes of DE-A 10246119 and DE-A 10245585.

Further starting reaction gas mixtures which are suitable in accordance with the invention may lie within the following composition framework:
from 7 to 11% by volume of propene,
from 6 to 12% by volume of water,
from ≧0 to 5% by volume of constituents other than propene, water, oxygen and nitrogen,
sufficient molecular oxygen that the molar ratio of oxygen present to molecular propene present is from 1.6 to 2.2, and,
as the remainder up to 100% by volume of the total amount, molecular nitrogen.

In the case of methacrolein as the target compound, the starting reaction gas mixture may in particular have the composition described in DE-A 44 07 020.

The reaction temperature for the propene partial oxidation when the annular unsupported catalysts obtainable as described are used is frequently from 300 to 380° C. The same also applies in the case of methacrolein as the target compound.

The reaction pressure for the aforementioned partial oxidations is generally from 0.5 or 1.5 to 3 or 4 bar.

The total hourly space velocity on the catalyst charge of starting reaction gas mixture in the aforementioned partial oxidations typically amounts to from 1000 to 10000 l (STP)/l·h, usually to from 1500 to 5000 l (STP)/l·h and often to from 2000 to 4000 l (STP)/l·h.

The propene to be used in the starting reaction gas mixture is in particular polymer-grade propene and chemical-grade propene, as described, for example, in DE-A 10232748.

The oxygen source used is normally air.

In the simplest case, the partial oxidation employing the annular unsupported catalysts obtainable as described may be carried out, for example, in a one-zone multiple catalyst tube fixed bed reactor, as described by DE-A 44 31 957, EP-A 700 714 and EP-A 700 893.

Typically, the catalyst tubes in the aforementioned tube bundle reactors are manufactured from ferritic steel and typically have a wall thickness of from 1 to 3 mm. Their internal diameter is generally from 20 to 30 mm, frequently from 22 to 26 mm. A typical catalyst tube length is, for example, 3.20 m. It is appropriate from an application point of view for the number of catalyst tubes accommodated in the tube bundle vessel to be at least 1000, preferably at least 5000. Frequently, the number of catalyst tubes accommodated in the reaction vessel is from 15 000 to 30 000. Tube bundle reactors having a number of catalyst tubes above 40 000 are usually exceptional. Within the vessel, the catalyst tubes are normally arranged in homogeneous distribution, and the distribution is appropriately selected in such a way that the separation of the central internal axes from immediately adjacent catalyst tubes (known as the catalyst tube pitch) is from 35 to 45 mm (cf. EP-B 468 290).

However, the partial oxidation may also be carried out in a multizone (for example two-zone) multiple catalyst tube fixed bed reactor, as recommended by DE-A 199 10 506, DE-A 10313213, DE-A 10313208 and EP-A 1 106 598, especially at elevated hourly space velocities on the catalyst charge of the organic compound to be partially oxidized. A typical catalyst tube length in the case of a two-zone multiple catalyst tube fixed bed reactor is 3.50 m. Everything else is substantially as described for the one-zone multiple catalyst tube fixed bed reactor. Around the catalyst tubes, within which the catalyst charge is disposed, a heat exchange medium is conducted in each heating zone. Useful such media are, for example, melts of salts such as potassium nitrate, potassium nitrite, sodium nitrite and/or sodium nitrate, or of low-melting metals such as sodium, mercury and also alloys of different metals. The flow rate of the heat exchange medium within the particular heating zone is generally selected in such a way that the temperature of the heat exchange medium rises from the entry point into the temperature zone to the exit point from the temperature zone by from 0 to 15° C., frequently from 1 to 10° C., or from 2 to 8° C., or from 3 to 6° C.

The entrance temperature of the heat exchange medium which, viewed over the particular heating zone, may be conducted in cocurrent or in countercurrent to the reaction gas mixture is preferably selected as recommended in the documents EP-A 1 106 598, DE-A 19948523, DE-A 19948248, DE-A 10313209, EP-A 700 714, DE-A 10313208, DE-A 10313213, WO 00/53557, WO 00/53558, WO 01/36364, WO 00/53557 and also the other documents cited as prior art in this document. Within the heating zone, the heat exchange medium is preferably conducted in a meandering manner. In general, the multiple catalyst tube fixed bed reactor additionally has thermal tubes for determining the gas temperature in the catalyst bed. Appropriately, the internal diameter of the thermal tubes and the diameter of the internal accommodating sleeve for the thermal element are selected in such a way that the ratio of volume developing heat of reaction to surface area removing heat for the thermal tube and working tubes is the same.

The pressure drop in the case of working tubes and thermal tube, based on the same GHSV, should be the same. The pressure drop may be equalized in the case of the thermal tube by adding spalled catalyst to the shaped catalyst bodies. This equalization is appropriately effected homogeneously over the entire thermal tube length.

To prepare the catalyst charge in the catalyst tubes, as already mentioned, it is possible only to use annular unsupported catalysts obtainable as described or, for example also substantially homogeneous mixtures of annular unsupported catalysts obtainable as described and shaped bodies which have no active composition and behave substantially inertly with respect to the heterogeneously catalyzed partial gas phase oxidation. Useful materials for such inert shaped bodies include, for example, porous or nonporous aluminum oxides, silicon dioxide, thorium dioxide, zirconium dioxide, silicon carbide, silicates such as magnesium or aluminum silicate or steatite (for example of the C220 type from CeramTec, Germany).

The geometry of such inert shaped diluent bodies may in principle be as desired. In other words, they may be, for example, spheres, polygons, solid cylinders or else, like the shaped catalyst bodies, rings. Frequently, the inert shaped diluent bodies selected will be those whose geometry corresponds to that of the shaped catalyst bodies to be diluted with them. However, along the catalyst charge, the geometry of the shaped catalyst body may also be changed or shaped catalyst bodies of different geometry may be used in a substantially homogeneous mixture. In a less preferred procedure, the active composition of the shaped catalyst body may also be changed along the catalyst charge.

Quite generally, as already mentioned, the catalyst charge is advantageously configured in such a way that the volume-specific (i.e. normalized to the unit of the volume) activity either remains constant or increases (continuously, sharply or stepwise) in the flow direction of the reaction gas mixture.

A reduction in the volume-specific activity may be achieved in a simple manner, for example, by homogeneously diluting a basic amount of annular unsupported catalysts prepared uniformly in accordance with the invention with inert shaped diluent bodies. The higher the proportion of the shaped diluent bodies selected, the lower the active composition or catalyst activity present in a certain volume of the charge. However, a reduction can also be achieved by changing the geometry of the annular unsupported catalysts obtainable according to the invention in such a way that the amount of active composition present in the unit of the total ring volume (including the ring orifice) becomes smaller.

For the heterogeneously catalyzed gas phase partial oxidations using the annular unsupported catalysts obtainable as described, the catalyst charge is preferably either configured uniformly with only one unsupported catalyst ring over the entire length or structured as follows. Initially to a length of from 10 to 60%, preferably from 10 to 50%, more preferably from 20 to 40% and most preferably from 25 to 35% (i.e., for example, to a length of from 0.70 to 1.50 m, preferably from 0.90 to 1.20 m), in each case of the total length of the catalyst charge, a substantially homogeneous mixture of annular unsupported catalyst obtainable according to the invention and inert shaped diluent bodies (both preferably having substantially the same geometry), the proportion by weight of the shaped diluent bodies (the mass densities of shaped catalyst bodies and of shaped diluent bodies generally differ only slightly) being normally from 5 to 40% by weight, or from 10 to 40% by weight, or from 20 to 40% by weight, or from 25 to 35% by weight. Downstream of this first charge section, there is then advantageously, up to the end of the length of the catalyst charge (i.e., for example, to a length of from 2.00 to 3.00 m, preferably from 2.50 to 3.00 m), either a bed of the annular unsupported catalyst obtainable as described which is diluted only to a lesser extent (than in the first section), or, most preferably, an unaccompanied (undiluted) bed of the same annular unsupported catalyst which has also been used in the first section. Of course, a constant dilution may also be selected over the entire charge. Charging may also be effected in the first section using only an annular unsupported catalyst obtainable according to the invention and having lower active composition density based on its space demands, and, in the second section, using an annular unsupported catalyst obtainable according to the invention having higher active composition density based on its space demands (for example 6.5 mm×3 mm×4.5 mm [E×L×I] in the first section, and 5×2×2 mm in the second section).

Overall, in a partial oxidation for preparing acrolein or methacrolein carried out using the annular unsupported catalysts obtainable as described, the catalyst charge, the starting reaction gas mixture, the hourly space velocity and the reaction temperature are generally selected in such a way that, on single pass of the reaction gas mixture through the catalyst charge, a conversion of the organic compound to be partially oxidized (propene, isobutane, tert-butanol or its methyl ether group) of at least 90 mol %, or 92 mol %, preferably of at least 95 mol %, results. The selectivity of acrolein or methacrolein formation will regularly be ≧94 mol %, or ≧95 mol %, or ≧96 mol %, or ≧97 mol %. Of course, very low hotspot temperatures are desired.

Overall, the annular unsupported catalysts obtainable as described bring about both an increased activity and an increased selectivity of target product formation.

Finally, it is emphasized that the annular unsupported catalysts obtainable as described also have advantageous fracture behavior in the course of reactor charging. Their pressure drop behavior is also advantageous. Otherwise, the annular unsupported catalysts obtainable as described are quite generally suitable as catalysts having increased activity and selectivity for catalytic partial oxidations in the gas phase of organic compounds such as lower (for example containing from 3 to 6 (i.e. 3, 4, 5, or 6) carbon atoms) alkanes, alkanols, alkanals, alkenes and alkenals to olefinically unsaturated aldehydes and/or carboxylic acids, and also the appropriate nitrites (ammoxidation, in particular of propene to acrylonitrile and of 2-methylpropene or tert-butanol (or its methyl ether) to methacrylonitrile) and also for catalytic oxidative dehydrogenations in the gas phase of organic compounds (for example containing 3, 4, 5, or 6 carbon atoms).

Particularly advantageous stoichiometries for the process of propylene partial oxidation to acrolein are:
a) [Bi₂W₂O₉.2WO₃]_{0.5}[Mo₁₂Co_{5.5}Fe_{2.94}Si_{1.59}Ko_{0.08}Oₓ]₁;
b) Mo₁₂Ni_{6.5}Zn₂Fe₂Bi₁P_{0.0065}K_{0.06}Oₓ.10SiO₂;
c) Mo₁₂Co₇Fe_{2.94}Bi_{0.6}Si_{1.59}K_{0.08}Oₓ;
d) as per multimetal oxide II unsupported catalyst according to Example 1 of DE-A 197 46 210; and
e) as per Example 1c of EP-A 015 565.

The bismuth content of the active compositions obtainable as described may also be adjusted as described in DE-A 100 63 162. In this method, a solution or suspension is generated from starting compounds of the elemental constituents of the desired active composition, said solution or suspension containing the total amount of elemental constituents other than Bi required to prepare the active composition, but only a portion of the Bi required to prepare the active composition, the solution or suspension is dried to obtain a dry mass and the remaining amount of Bi additionally required to form the active composition is incorporated into this dry mass in the form of a starting compound of Bi, as described in DE-A 100 63 162, to obtain a shapeable mixture (for example as in the example of DE-A 100 63 162), the shapeable mixture is shaped to an annular shaped unsupported catalyst body in the inventive manner (i.e. after adding shaping and/or reinforcing assistants), and this is then converted to the desired annular unsupported catalyst by thermal treatment (for example as in the Example in DE-A 100 63 162). The stoichiometries (especially of the examples) and thermal treatment conditions of this (aforementioned) document are likewise particularly suitable propylene partial oxidation to acrolein. This is especially true of the stoichiometry Mo₁₂Bi_{1.0}Fe₃CO₇Si_{1.6}K_{0.08}.

The start-up of a fresh catalyst charge comprising annular unsupported catalysts obtainable as described may be effected as described in DE-A 10337788. In general, activity and selectivity of the target product formation initially increase with the operating time of the catalyst charge. This conditioning may be accelerated by carrying it out at substantially uniform conversion under increased hourly space velocity on the catalyst charge of starting reaction gas mixture, and, after substantially completed conditioning, reducing the hourly space velocity to its target value.

It is surprising that the ratio R of apparent mass density to true mass density ρ (as defined in EP-A 1340538) in the annular unsupported catalysts obtainable as described is generally >0.55. R is usually ≦0.9 or ≦0.8 and ≧0.6 or ≧0.65.
R=1/(1+V·ρ).
V is the total pore volume.

The present invention further relates in particular to a process for preparing annular shaped catalyst bodies with curved and/or uncurved top surface of the rings, whose active composition has a stoichiometry of the general formula IV
Mo₁₂PₐV_{b}X_{c}¹X_{d}²Xₑ³Sb_{f}Re_{g}SₕOₙ (IV)
in which the variables are each defined as follows:
X¹=potassium, rubidium and/or cesium,
X²=copper and/or silver,
X³=cerium, boron, zirconium, manganese and/or bismuth,
a=from 0.5 to 3,
b=from 0.01 to 3,
c=from 0.2 to 3,
d=from 0.01 to 2,
e=from 0 to 2,
f=from 0.01 to 2,
g=from 0 to 1,
h=from 0.001 to 0.5 and
n=a number which is determined by the valency and frequency of the elements in IV other than oxygen,
   and whose annular geometry corresponds to that of the annular shaped catalyst bodies already described with active compositions of a stoichiometry of the general formula (I), (II) or (III).

Preference is given to active compositions IV in which h is from 0.03 to 0.5.

Particularly preferred stoichiometry of the general formula IV is that of the Working Examples B1 to B15 from EP-A 467 144, even when these exemplary active compositions do not comprise any K.

The aforementioned EP-A 467 144 also describes the preparation of such annular shaped catalyst bodies and their use as catalysts for the heterogeneously catalyzed gas phase partial oxidation of methacrolein to methacrylic acid. These descriptions also apply in the context given in the present application, apart from the fact that boron nitride is to be used in accordance with the invention as a lubricant in the preparation of the annular shaped catalyst bodies.

In other words, annular shaped catalyst bodies with active compositions of the general stoichiometry IV can be prepared by finely dividing salts, suitable as starting compounds, of the element constituents constituting them, if appropriate at elevated temperature and with addition of acids or bases, in aqueous medium by dissolution and/or suspension, and mixing them, if appropriate under inert gas to avoid undesired oxidation processes, concentrating the mixture to dryness, adding the boron nitride required in accordance with the invention and, if appropriate, others of the shaping assistants and reinforcing assistants mentioned to the resulting dry mass in finely divided form or having been converted to finely divided form, shaping (compacting) the resulting finely divided mass to the desired ring geometry and subsequently treating the resulting shaped catalyst precursor bodies thermally. Preference is given to carrying out the thermal treatment at temperatures of from 180 to 480° C., more preferably at temperatures of from 250 to 450° C. The thermal treatment can be effected under the gas atmospheres already described. Mention should be made by way of example once again of flowing air, flowing inert atmosphere (for example N₂, or CO₂, or noble gases) or reduced pressure. The thermal treatment can be carried out in a plurality of temperature stages and/or in various atmospheres. For example, it is possible to treat thermally at from 200 to 260° C. in air in a first stage, at from 420 to 460° C. in nitrogen in a second stage and at from 350 to 410° C. again in air in a third stage. In general, flowing air is the preferred atmosphere for the thermal treatment.

Otherwise, the statements made for the preparation of annular shaped catalyst bodies of active compositions (I), (II) and (III) applies here in a corresponding manner, except with the difference that the increased side crushing strengths are preferred here for the annular shaped unsupported catalyst precursor bodies.

In other words, for example, a preferred drying process for the aqueous solution or suspension of the sources of the elemental constituents of the desired active composition is spray drying. The resulting spray powder with a typically granularity of from 20 to 50 μm is advantageously in accordance with the invention, and appropriately in accordance with the invention after addition of finely divided boron nitride as an assistant, intermediately compacted in order to coarsen the powder. Preference is given to effecting the intermediate compaction here to particle diameters of from 100 to 2000 μm, preferably from 150 to 1500 μm and more preferably from 400 to 1000 μm. Subsequently, the actual shaping is effected on the basis of the coarsened powder, and it is possible if required again to add finely divided inventive boron nitride (and, if appropriate, further shaping and/or reinforcing assistants) beforehand. The statements made on the side crushing strengths for the preparation of the annular shaped catalyst bodies of the active compositions (I), (II) and (III) applies here analogously.

In the preparation method described of annular shaped catalyst bodies from active compositions of the general formula IV, antimony is used typically in the form of antimony trioxide, rhenium for example, in the form of rhenium(VII) oxide, molybdenum preferably in the form of the ammonium salt of molybdic acid or phosphomolybdic acid, boron, for example, in the form of boric acid, vanadium generally in the form of ammonium vanadate or vanadium oxalate, phosphorus advantageously in the form of orthophosphoric acid or diammonium phosphate, sulfur, for example, in the form of ammonium sulfate, and the cationic metals normally in the form of the nitrates, oxides, hydroxides, carbonates, chlorides, formates, oxalates and/or acetates or the hydrates thereof. Preferred ring geometry of the finished shaped catalyst body here is the geometry 7 mm×7 mm×3 mm (external diameter×length×internal diameter). The catalytic gas phase oxidation of methacrolein to methacrylic acid using the annular shaped catalyst bodies obtainable as described can be effected in a manner known per se, for example that described in EP-A 467 144. The oxygen oxidant can be used, for example, in the form of air, but also in pure form. Owing to the high heat of reaction, the reactants are preferably diluted with inert gases such as N₂, CO, CO₂ and/or with steam. Preference is given to working at a methacrolein:oxygen:steam:inert gas ratio of 1:(1 to 3):(2 to 20):(3 to 30), more preferably of 1:(1 to 3):(3 to 10):(7 to 18). The proportion of methacrolein in the starting reaction gas mixture varies generally from 4 to 11% by volume, in many cases from 4.5 to 9% by volume. To avoid explosive mixtures, the oxygen content is preferably restricted to ≦12.5% by volume. This is more preferably achieved by recycling a substream of the offgas removed from the reaction product. Otherwise, the gas phase partial oxidation to methacrylic acid is typically effected at total spatial loadings on the fixed catalyst bed of from 800 to 1800 l (STP)/l·h, or at methacrolein loadings of from 60 to 140 l (STP)/l·h. The reactor used is generally a tube bundle reactor. Reaction gas and salt bath can, viewed over the reactor, be conducted either in cocurrent or in countercurrent. The salt bath instead is normally conducted through the reactor in meandering form. Preferred boron nitride for preparing annular shaped catalyst bodies composed of active compositions of the general stoichiometry IV is likewise Boron Nitride Grade A 01, Number PD-5006, Issue 0.-07.99 from H. C. Starck.

The process according to the invention also comprises in particular a process for preparing annular shaped catalyst bodies with curved and/or uncurved top surface of the rings, whose active composition is a multimetal oxide comprising vanadium, phosphorus and oxygen, and which are suitable as catalysts for the heterogeneously catalyzed gas phase oxidation of at least one hydrocarbon having at least four carbon atoms (especially n-butane, n-butene and/or benzene) to maleic anhydride. The preparation of appropriate annular shaped catalyst bodies is described in WO 03/078310 with addition of graphite as a shaping assistant. All remarks of WO 03/078310 und all catalysts addressed in WO 03/078310 still have load-bearing capacity and the employability addressed in WO 03/078310 when the preparation measures disclosed in WO 03/078310 are retained, and the graphite additionally used in the preparation is replaced in accordance with the invention by identical weights of boron nitride. Here too, preference is given in accordance with the invention to employing Boron Nitride Grade A 01, Number PD-5006, Issue 0-07.99 from H. C. Starck as a graphite replacement. In the aforementioned case of annular multimetal oxide catalysts comprising vanadium, phosphorus and oxygen too, the advantages of the invention are established. This is true in particular of all working examples of WO 03/078310.

The process according to the invention also comprises in particular processes for preparing inventive, for example spherical, solid cylindrical or annular shaped catalyst bodies with curved and/or uncurved top surface of the rings, whose active composition is a multimetal oxide comprising Mo, V and at least one of the elements Te and Sb, as described, for example, in the documents EP-A 962 253, DE-A 101 22 027, EP-A 608 838, DE-A 198 35 247, EP-A 895 809, EP-A 1 254 709, EP-A 1 192 987, EP-A 1 262 235, EP-A 1 193 240, JP-A 11-343261, JP-A 11-343262, EP-A 1 090 684, EP-A 1 301 457, EP-A 1 254 707, EP-A 1 335 793, DE-A 100 46 672, DE-A 100 34 825, EP-A 1 556 337, DE-A 100 33 121, WO 01/98246, EP-A 1 558 569.

Frequently, the aforementioned multimetal oxide compositions also comprise the element Nb. The aforementioned multimetal oxide catalysts are suitable in inventive preparation for all catalyzed gas phase reactions carried out in the aforementioned documents. These are in particular the heterogeneously catalyzed partial gas phase oxidation of propane to acrylic acid and of acrolein to acrylic acid, of methacrolein to methacrylic acid and of isobutane to methacrylic acid.

Finally, it should also be emphasized at this point that shaped catalyst bodies prepared in accordance with the invention do not necessarily have to be used as such as catalysts for heterogeneously catalyzed gas phase reactions. Instead, they can be subjected to grinding and, after classification of the resulting finely divided material, applied with the aid of a suitable liquid binder to the surface of a suitable support body. After drying or directly after application of the active composition coating to the support body, the resulting coated catalyst can be used as a catalyst for heterogeneously catalyzed gas phase reactions, as described, for example, in DE-A 101 22 027.

In summary, it should be emphasized once again that the shaped catalyst bodies obtainable in accordance with the invention are outstandingly suitable as catalysts for heterogeneously catalyzed reactions in the gas phase. These gas phase reactions include in particular the partial oxidations of organic compounds, the partial ammoxidations of organic compounds and the oxydehydrogenations of organic compounds. Useful partial heterogeneously catalyzed oxidations of organic compounds include in particular those mentioned in DE-A 10 2004 025 445. Mention should once again be made by way of example of the conversion of propylene to acrolein and/or acrylic acid (cf., for example, DE-A 23 51 151), the conversion of tert-butanol, isobutene, isobutane, isobutyraldehyde or the methyl ether of tert-butanol to methacrolein and/or methacrylic acid (cf. for example, DE-A 25 26 238, EP-A 092 097, EP-A 58927, DE-A 4132263, DE-A 4132684 and DE-A 4022212), the conversion of acrolein to acrylic acid, the conversion of methacrolein to methacrylic acid (cf., for example, DE-A 2526238), the conversion of o-xylene, p-xylene or naphthalene to phthalic anhydride (cf., for example, EP-A 522 871) or the corresponding acids, and also the conversion of butadiene to maleic anhydride (cf., for example, DE-A 21 06 796 and DE-A 16 24 921), the conversion of n-butane to maleic anhydride (cf., for example, GB-A 1 464 198 and GB-A 1 291 354), the conversion of indenes to, for example, anthraquinone (cf., for example, DE-A 20 25 430), the conversion of ethylene to ethylene oxide or of propylene to propylene oxide (cf., for example, DE-B 12 54 137, DE-A 21 59 346, EP-A 372 972, WO 89/07101, DE-A 43 11 608 and Beyer, Lehrbuch der organischen Chemie [Textbook of organic chemistry], 17th Edition (1973), Hirzel Verlag, Stuttgart, p. 261), the conversion of propylene and/or acrolein to acrylonitrile (cf., for example, DE-A 23 51 151), the conversion of isobutene and/or methacrolein to methacrylonitrile (i.e., in this document, the term partial oxidation shall also comprise partial ammoxidation, i.e. partial oxidation in the presence of ammonia), the oxidative dehydrogenation of hydrocarbons (cf., for example, DE-A 23 51 151), the conversion of propane to acrylonitrile or to acrolein and/or acrylic acid (cf., for example, DE-A 101 31 297, EP-A 1 090 684, EP-A 608 838, DE-A 100 46 672, EP-A 529 853, WO 01/96270 and DE-A 100 28 582), the conversion of isobutane to methacrolein and/or methacrylic acid, and also the reaction of ethane to give acetic acid, of ethylene to give ethylene oxide, of benzene to give phenol, and of 1- or 2-butene to give the corresponding butanediols.

It will be appreciated that the gas phase reaction may also be a heterogeneously catalyzed hydrogenation or a heterogeneously catalyzed dehydrogenation of organic compounds. It is notable especially for the long-term stability of the catalysts, even when hotspots (maximum reaction temperatures) which correspond substantially to the temperatures employed in the thermal treatment in the inventive catalyst preparation occur in the reactions, for example in tube bundle reactors.

Quite generally, the process according to the invention leads to multielement oxide catalysts which, based on the multielement oxide composition, comprise from 0.1 to 20% by weight or to 10% by weight, or from 0.3 to 8% by weight, in many cases from 0.5 to 6% by weight or from 0.5 to 5% by weight of boron nitride. The latter is detectable readily in the X-ray diffractogram of the multielement oxide catalyst.

Examples and comparative examples (the lubricating assistant used is always retained in the preparation but is not listed as a constituent of the active composition owing to its inertness)

I. Comparative Examples for a Heterogeneously Catalyzed Partial Oxidation of Propene to Acrolein

A) Preparation of Annular Unsupported Catalysts with the Following Stoichiometry S1 of the Active Composition: Mo₁₂CO₇Fe_{2.94}Bi_{0.6}Si_{1.59}K_{0.08}Oₓ.

At 60° C., 213 kg of ammonium heptamolybdate tetrahydrate (81.5% by weight of MoO₃) were dissolved in 600 l of water. 0.97 kg of a 46.8% by weight aqueous potassium hydroxide at 20° C. were stirred into this solution while maintaining the 60° C. (to obtain a solution A).

A second solution B was prepared by adding, at 30° C. with stirring, 116.25 kg of an aqueous iron(III) nitrate solution (14.2% by weight of Fe) at 20° C. to 333.7 kg of an aqueous cobalt(II) nitrate solution (12.4% by weight of Co). On completion of addition, the mixture was stirred at 30° C. for another 30 min. Thereafter, 112.3 kg of an aqueous bismuth nitrate solution (11.2% by weight of Bi) at 20° C. were stirred in at 60° C. to obtain solution B. Within 30 min, solution B was stirred into solution A at 60° C. 15 min. after completion of stirring-in, 19.16 kg of silica sol (from Du Pont, Ludox® type, 46.80% by weight of SiO₂, density: from 1.36 to 1.42 g/cm³, pH=8.5 to 9.5, alkali content max. 0.5% by weight) were added at 60° C. to the resulting slurry. While maintaining the 60° C., the mixture was stirred for another 15 min. The resulting slurry was then spray-dried in a countercurrent process (gas inlet temperature: 400±10° C., gas outlet temperature: 140±5° C.) to obtain a spray powder whose ignition loss (3 h at 600° C. under air) was 30% of its weight. The granularity of the spray powder was a substantially uniform 30 μm.

In each case an additional 1.5% by weight (based on the amount of spray powder) of finely divided synthetic graphite of the TIMREX T44 type from Timcal AG (Bodio, Switzerland) were mixed into portions of the resulting spray powder. It has the following purity and other properties:

| | | |
|---|---|---|
| Ash residue (ignition at 815° C. under air) | 0.07% | by weight |
| Moisture content (under standard conditions) | 0.1% | by weight |
| Al | 15 | ppm by weight |
| As | <0.5 | ppm by weight |
| Ca | 100 | ppm by weight |
| Co | <1 | ppm by weight |
| Cr | <1 | ppm by weight |
| Cu | <1 | ppm by weight |
| Fe | 60 | ppm by weight |
| Mo | <1 | ppm by weight |
| Ni | 2 | ppm by weight |
| Pb | <2 | ppm by weight |
| Sb | <0.1 | ppm by weight |
| Si | 80 | ppm by weight |
| Ti | 150 | ppm by weight |
| V | 17 | ppm by weight |
| S | 60 | ppm by weight |

Specific BET surface area: from 6 to 13 m²/g, typically 10 m²/g

| | |
|---|---|
| Typical particle size distribution (Malvern laser) | D10: 4.8 μm |
| | D50: 19.3 μm |
| | D90: 44.7 μm |
| Variation | D90: 37 to 52 μm |

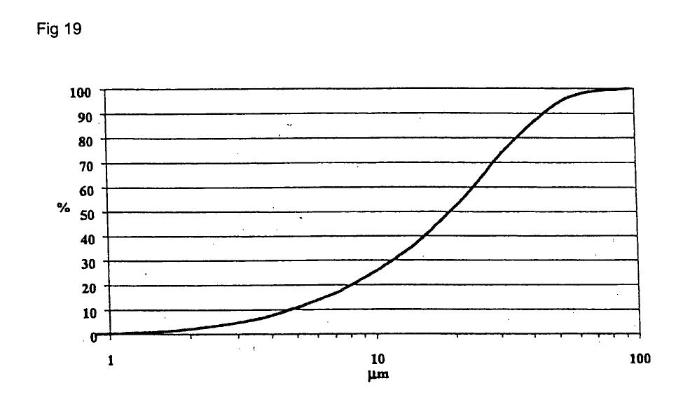

The total particle size distribution is shown in FIG. 19. In this figure, the abscissa shows the diameter on a logarithmic scale. The ordinate shows the percentage of the number of particles with the particular diameter.

| Crystallite height | min. 100 | nm |
|---|---|---|
| Interlayer distance | 0.3354-0.3359 | nm |

The dry mixture resulting in each case was coarsened by means of a K 200/100 compactor from Hosokawa Bepex GmbH (D-74211 Leingarten) under the conditions of gap width 2.8 mm, sieve width 1.0 mm, undersize particle sieve width 400 μm, target compressive force 60 kN and screw rotation speed from 65 to 70 μm, by precompaction to a substantially uniform particle size of from 400 μm to 1 mm. The compactate had a hardness of 10 N.

The compactate was subsequently mixed with, based on its weight, a further 2% by weight of the same graphite and subsequently compacted in a Kilian Rx73 rotary tableting press (tableting machine) from Kilian, D-50735 Cologne, under a nitrogen atmosphere to give annular shaped unsupported catalyst precursor bodies with uncurved top surface and of the geometry 5 mm×3 mm×2 mm (E×L×I) and having varying side crushing strength.

The resulting shaped unsupported catalyst precursor bodies and their side crushing strengths were:
CUP 1: 15 N;
CUP 2: 20 N.

For final thermal treatment, in each case 1900 g of the shaped unsupported catalyst precursor bodies were charged in a heatable forced-air chamber (capacity 0.12 m³, 2 m³ (STP) of air/min.). Subsequently, the temperature in the bed was changed as follows:
increased from 25° C. to 160° C. at 1° C./min.;
then held at 160° C. for 100 min.;
afterward increased from 160° C. to 200° C. at 3° C./min.;
then held at 200° C. for 100 min.;
afterward increased from 200° C. to 230° C. at 2° C./min.;
then held at 230° C. for 100 min.;
afterward increased from 230° C. to 270° C. at 3° C./min.;
then held at 270° C. for 100 min.;
afterward increased to 380° C. at 1° C./min.;
then held at 380° C. for 4.5 h;
afterward increased to 430° C. at 1° C./min.;
then held at 430° C. for 4.5 h;
afterward increased to 50° C. at 1° C./min.;
then held at 500° C. for 9 h;
afterward cooled to 25° C. within 4 h.

The following annular unsupported catalysts were obtained from the annular shaped unsupported catalyst precursors (the first letter C for comparative example):
CUP 1→CUC 1;
CUP 2→CUC 2.

The parameters S, V, the significant pore diameter d^{max} which makes the greatest contribution to the total pore volume and the percentage of those pore diameters in the total pore volume whose diameters are >0.1 and <1 μm, of these annular unsupported catalysts were as follows:
CUC 1: S=6.4 m²/g; V=0.32 cm³/g; d^{max}=0.32 μm; V^{0.1}₁-%=91%.
CUC 2: S=6.8 m²/g; V=0.34 cm³/g; d^{max}=0.36 μm; V^{0.1}₁-%=87%.

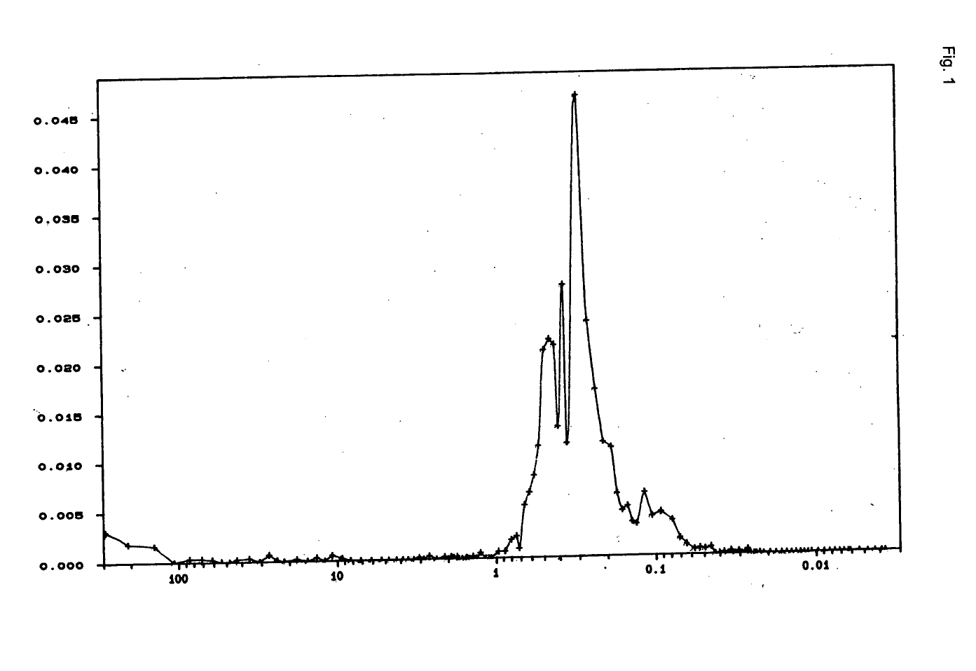

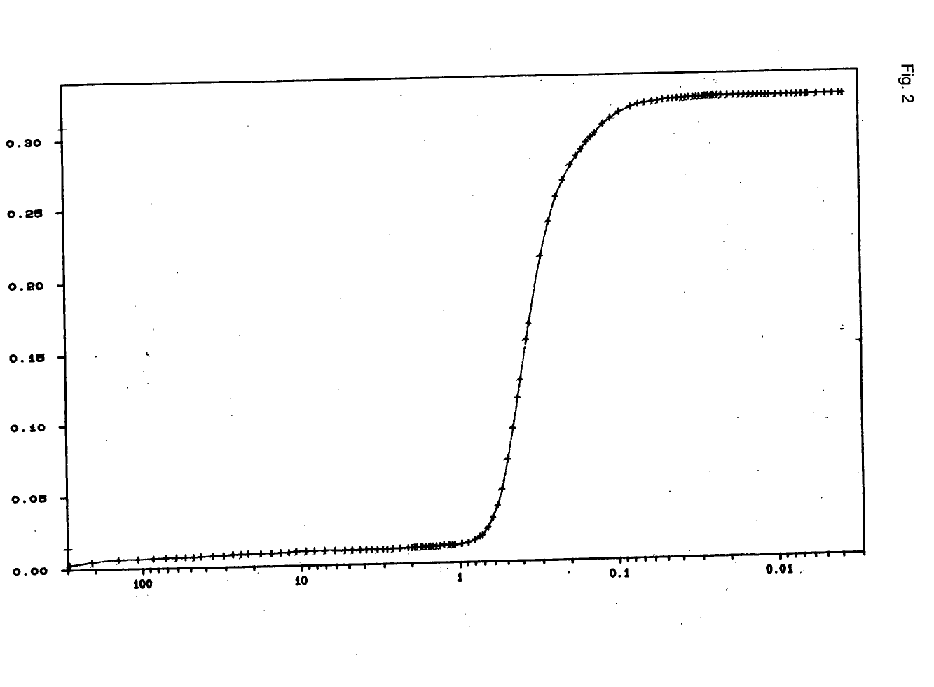

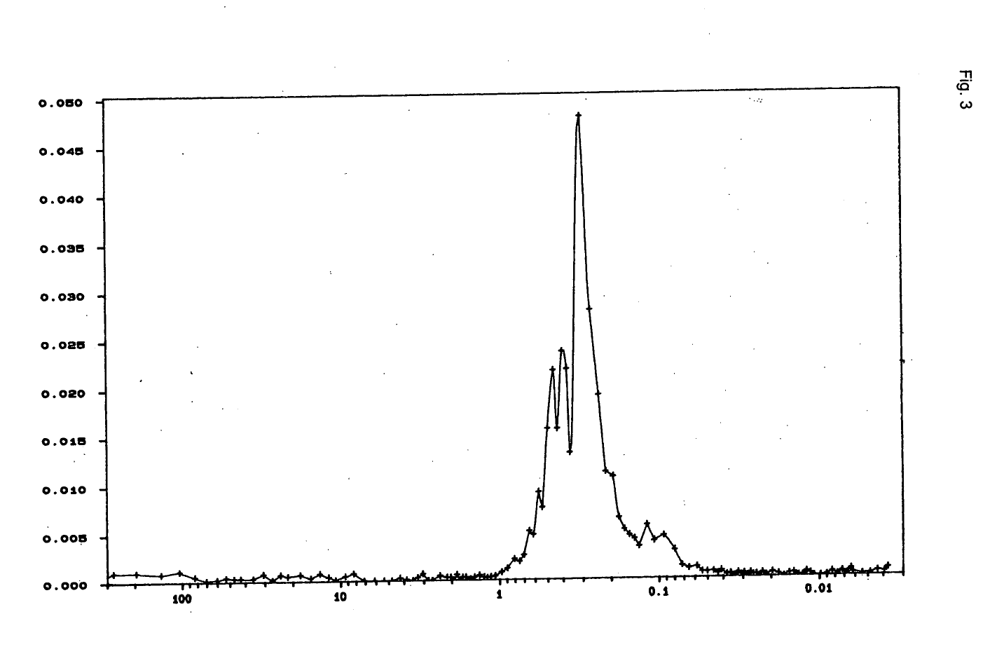

FIGS. 1 (3) and 2 (4) also show the pore distribution of the annular unsupported catalyst CUC1 (CUC2). In FIG. 1(3), the abscissa shows the pore diameter in μm and the ordinate the different contribution in ml/g of the particular pore diameter to the total pore volume. In FIG. 2(4), the abscissa likewise shows the pore diameter in μm and the ordinate the integral over the individual contributions of the individual pore diameters to the total pore volume in ml/g.

(Instead of carrying out the thermal treatment as described, it may also be carried out as described in Example 3 of DE-A 10046957 by means of a belt calcining apparatus; the chambers have a surface area (with a uniform chamber length of 1.40 m) of 1.29 m² (decomposition, chambers 1-4) and 1.40 m² (calcining, chambers 5-8) and are flowed through from below through the coarse-mesh belt by 70-120 m³ (STP) of forced air, preferably by 75 m³ (STP) of forced air, which is aspirated by means of rotating ventilators; within the chambers, the temporal and local deviation of the temperature from the target value was always ≦2° C.; the annular shaped unsupported catalyst precursor bodies are conducted through the chambers in a layer height of from 50 mm to 110 mm, preferably of from 50 mm to 70 mm; otherwise, the procedure is as described in Example 3 of DE-A 10046957; like the annular unsupported catalysts CUC1 and CUC2, the resulting annular unsupported catalysts may be used for the catalytic partial oxidation in the gas phase of propene to acrolein described hereinbelow under C)).

B) Preparation of Annular Unsupported Catalysts Having the Following Stoichiometry S2 of the Active Composition:
[Bi₂W₂O₉.2WO₃]_{0.5}[Mo₁₂Co_{5.5}Fe_{2.94}Si_{1.59}K_{0.08}Oₓ]₁.
1. Preparation of a Starting Composition 1

209.3 kg of tungstic acid (72.94% by weight of W) were stirred in portions into 775 kg of an aqueous bismuth nitrate solution in nitric acid (11.2% by weight of Bi; free nitric acid from 3 to 5% by weight; mass density: 1.22 to 1.27 g/ml) at 25° C. The resulting aqueous mixture was subsequently stirred at 25° C. for a further 2 h and subsequently spray-dried.

The spray-drying was effected in a rotating disk spray tower in countercurrent at a gas inlet temperature of 300±10° C. and a gas outlet temperature of 100±10° C. The resulting spray powder (particle size a substantially uniform 30 μm) which had an ignition loss of 12% by weight (ignite at 600° C. under air for 3 h) was subsequently converted to a paste in a kneader using 16.8% by weight (based on the powder) of water and extruded by means of an extruder (torque: ≦50 Nm) to extrudates of diameter 6 mm. These were cut into sections of 6 cm, dried under air on a 3-zone belt dryer at a residence time of 120 min at temperatures of 90-95° C. (zone 1), 115° C. (zone 2) and 125° C. (zone 3), and then thermally treated at a temperature in the range from 780 to 810° C. (calcined; in a rotary tube oven flowed through by air (0.3 mbar of reduced pressure, capacity 1.54 m³, 200 m³ (STP) of air/h)). When precisely adjusting the calcination temperature, it is essential that it has to be directed to the desired phase composition of the calcination product. The desired phases are WO₃ (monoclinic) and Bi₂W₂O₉; the presence of γ-Bi₂WO₆ (russellite) is undesired. Therefore, should the compound γ-Bi₂WO₆ still be detectable by a reflection at a reflection angle of 2Θ=28.4° (CuKα-radiation) in the x-ray powder diffractogram after the calcination, the preparation has to be repeated and the calcination temperature increased within the temperature range specified or the residence time increased at constant calcination temperature, until the disappearance of the reflection is achieved. The preformed calcined mixed oxide obtained in this way was ground so that the X₅₀ value (cf. Ullmann's Encyclopedia of Industrial Chemistry, 6^{th} Edition (1998) Electronic Release, Chapter 3.1.4 or DIN 66141) of the resulting particle size was 5 μm. The ground material was then mixed with 1% by weight (based on the ground material) of finely divided SiO₂ from Degussa of the Sipernat® type (bulk density 150 g/l; X₅₀ value of the SiO₂ particles was 10 μm, the BET surface area was 100 m²/g). Alternatively only 0.5% by weight of Sipernat can be applied.

2. Preparation of a Starting Composition 2

A solution A was prepared by dissolving 213 kg of ammonium heptamolybdate tetrahydrate (81.5% by weight of MoO₃) at 60° C. with stirring in 600 l of water and the resulting solution was admixed while maintaining the 60° C. and stirring with 0.97 kg of an aqueous potassium hydroxide solution (46.8% by weight of KOH) at 20° C.

A solution B was prepared by introducing 116.25 kg of an aqueous iron(III) nitrate solution (14.2% by weight of Fe) at 60° C. into 262.9 kg of an aqueous cobalt(II) nitrate solution (12.4% by weight of Co). Subsequently, while maintaining the 60° C., solution B was continuously pumped into the initially charged solution A over a period of 30 minutes. Subsequently, the mixture was stirred at 60° C. for 15 minutes. 19.16 kg of a Ludox silica gel from DuPont (46.80% by weight of SiO₂, density: from 1.36 to 1.42 g/ml, pH from 8.5 to 9.5, max. alkali content 0.5% by weight) were then added to the resulting aqueous mixture, and the mixture was stirred afterward at 60° C. for a further 15 minutes.

Subsequently, the mixture was spray-dried in countercurrent in a rotating disk spray tower (gas inlet temperature: 400±10° C., gas outlet temperature: 140±5° C.). The resulting spray powder had an ignition loss of approx. 30% by weight (ignite under air at 600° C. for 3 h) and a substantially uniform particle size of 30 μm.

3. Preparation of the Multimetal Oxide Active Composition

The starting composition 1 was mixed homogeneously with the starting composition 2 in the amounts required for a multimetal oxide active composition of the stoichiometry
[Bi₂W₂O₉.2WO₃]_{0.5}[Mo₁₂Co_{5.5}Fe_{2.94}Si_{1.59}K_{0.08}Oₓ]₁
in a mixer having bladed heads. Based on the aforementioned overall composition, an additional 1% by weight of finely divided graphite already mentioned, from Timcal AG (Bodio, Switzerland) of the TIMREX T44 type was mixed in homogeneously. The resulting mixture was then conveyed in a compactor (from Hosokawa Bepex GmbH, D74211 Leingarten) of the K200/100 compactor type having concave, fluted smooth rolls (gap width: 2.8 mm, sieve width: 1.0 mm, lower particle size sieve width: 400 μm, target compressive force: 60 kN, screw rotation rate: from 65 to 70 revolutions per minute). The resulting compactate had a hardness of 10 N and a substantially uniform particle size of from 400 μm to 1 mm.

The compactate was subsequently mixed with, based on its weight, a further 2% by weight of the same graphite and subsequently compressed in a Kilian R×73 rotary tableting press from Kilian, D-50735 Cologne, under a nitrogen atmosphere to give annular shaped unsupported catalyst precursor bodies of varying geometry (E×L×I) having varying side crushing strength.

The resulting shaped unsupported catalyst precursor bodies, their geometries and their side crushing strengths were:

| | | |
|---|---|---|
| CUP3: | 5 mm × 3 mm × 2 mm; | 19 N |
| | | (mass: 129 mg). |
| CUP4: | 5 mm × 3 mm × 3 mm; | 16 N. |
| CUP5: | 5 mm × 3 mm × 3 mm; | 17 N. |
| CUP6: | 5.5 mm × 3 mm × 3.5 mm; | 14 N. |
| CUP7: | 5.5 mm × 3 mm × 3.5 mm; | 15.5 N. |
| CUP8: | 6 mm × 3 mm × 4 mm; | 13 N. |
| CUP9: | 6 mm × 3 mm × 4 mm; | 16.3 N. |
| CUP10: | 6.5 mm × 3 mm × 4.5 mm; | 15.6 N. |
| CUP11: | 7 mm × 3 mm × 5 mm; | 16.3 N. |

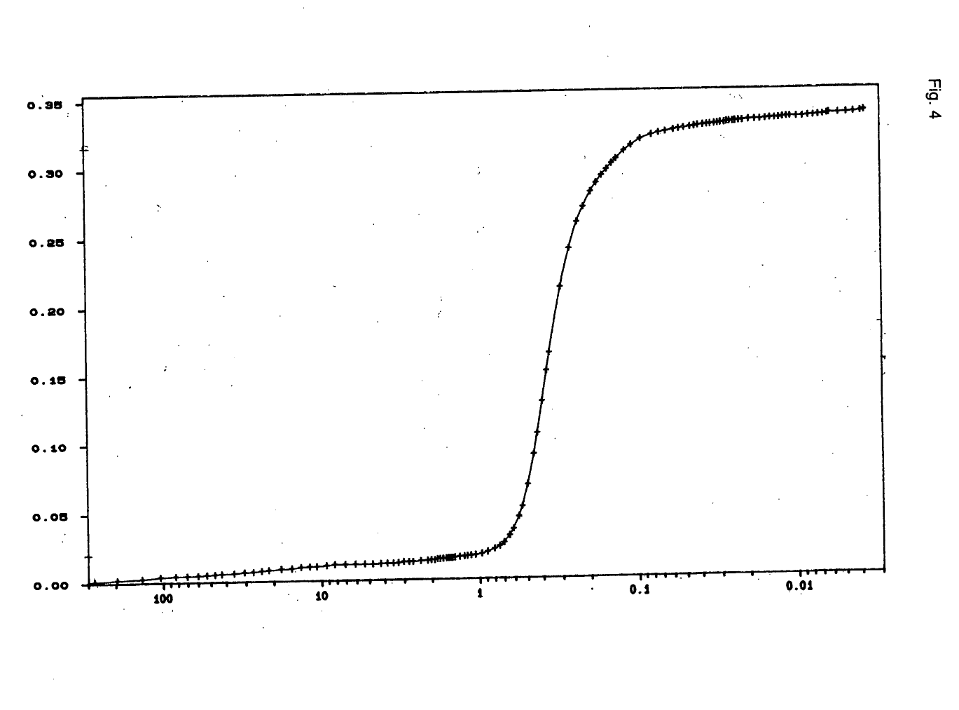

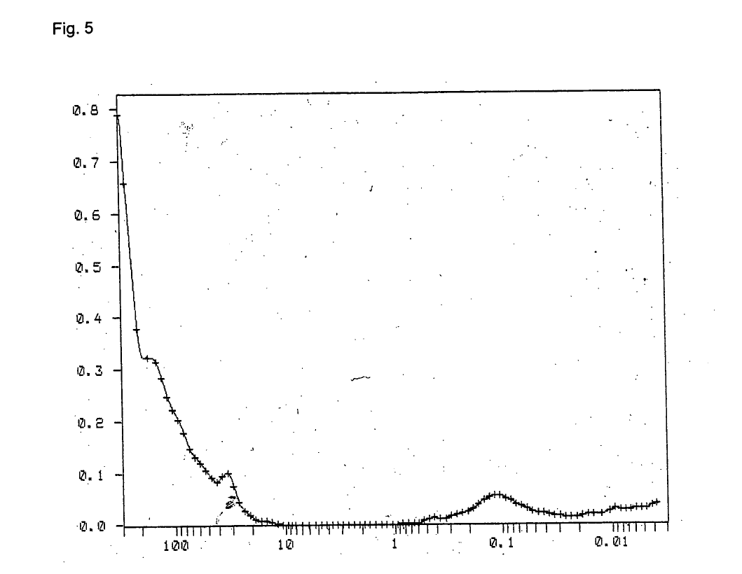

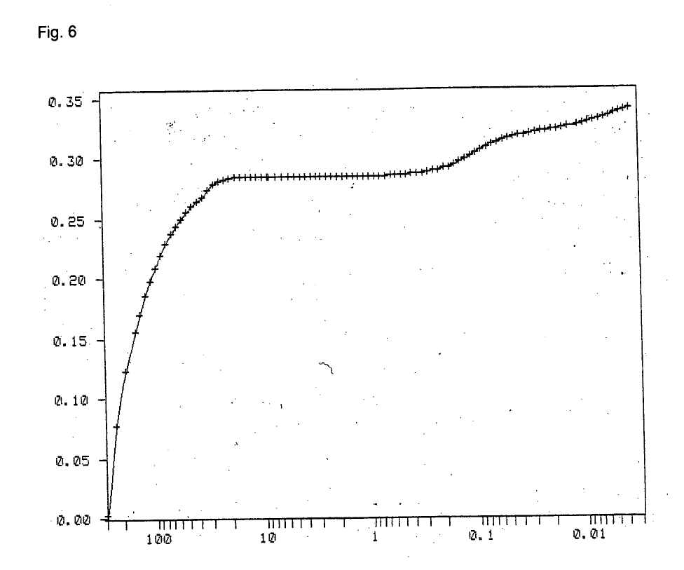

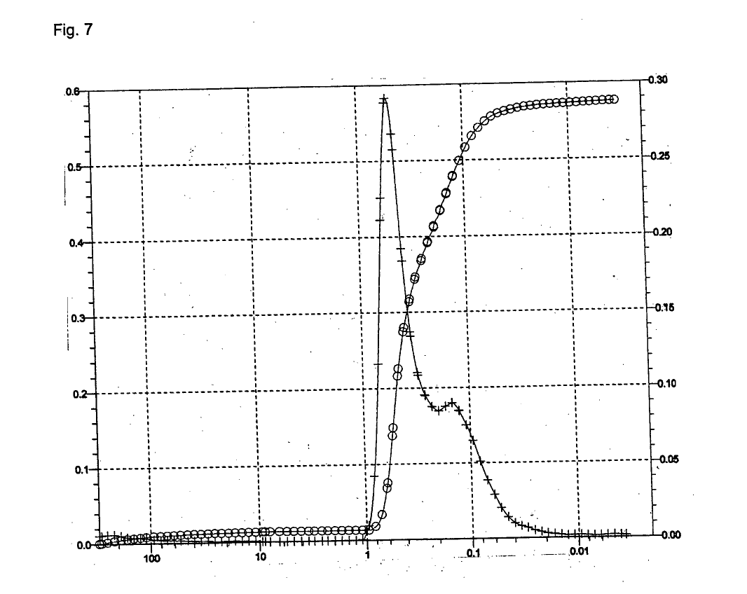

FIG. 5(6) shows the pore distribution in the annular shaped unsupported catalyst precursor body CUP3. The axis title of FIG. 5 corresponds to that of FIG. 7 and the axis title of FIG. 6 corresponds to that of FIG. 2.

For the final thermal treatment, in each case 1000 g of the shaped unsupported catalyst precursor bodies were heated in a muffle furnace flowed through by air (capacity 60 l, 1 l/h of air per gram of shaped unsupported catalyst precursor body) initially from room temperature (25° C.) to 190° C. at a heating rate of 180° C./h. This temperature was maintained for 1 h and then increased to 210° C. at a heating rate of 60° C./h. The temperature of 210° C. was in turn maintained over 1 h before it was increased to 230° C. at a heating rate of 60° C./h. This temperature was likewise maintained for 1 h before it was increased to 265° C., again at a heating rate of 60° C./h. The temperature of 265° C. was subsequently likewise maintained over 1 h. Afterward, the furnace was initially cooled to room temperature and the decomposition phase thus substantially completed. The furnace was then heated to 465° C. at a heating rate of 180° C./h and this calcination temperature maintained over 4 h.

The annular shaped unsupported catalyst precursor bodies were used to obtain the following annular unsupported catalysts (the first letter C stands in each case for comparative example):

| | S [m²/g] | V [cm³/g] | d^{max} [μm] | V^{0.1}₁-% | R |
|---|---|---|---|---|---|
| CUP3 → CUC3 | 7.6 | 0.27 | 0.6 | 79 | 0.66 |
| CUP4 → CUC4 | 6.9 | 0.23 | 0.45 | 70 | — |
| CUP5 → CUC5 | — | — | — | — | — |
| CUP6 → CUC6 | 7.45 | 0.21 | 0.40 | 74 | — |
| CUP7 → CUC7 | 7.95 | 0.205 | 0.39 | 73 | 0.68 |
| CUP8 → CUC8 | 7.6 | 0.22 | 0.45 | 74 | — |
| CUP9 → CUC9 | 9.61 | 0.22 | 0.30 | 70 | 0.68 |
| CUP10 → CUC10 | — | — | — | — | — |
| CUP11 → CUC11 | — | — | — | — | — |

In addition, the table above contains values for the specific surface area S, the total pore volume V, the pore diameter d^{max} which makes the greatest contribution to the total pore volume, and the percentage of those pore diameters in the total pore volume whose diameters are >0.1 and <1 μm, and R values.

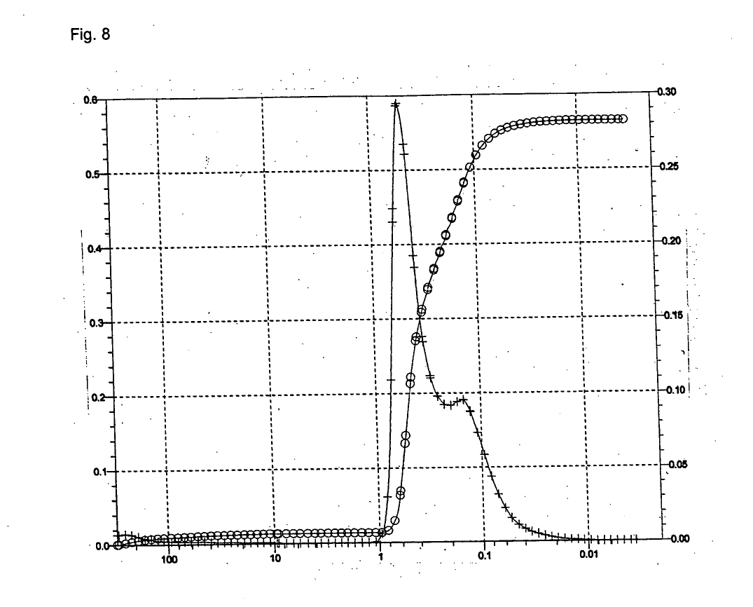

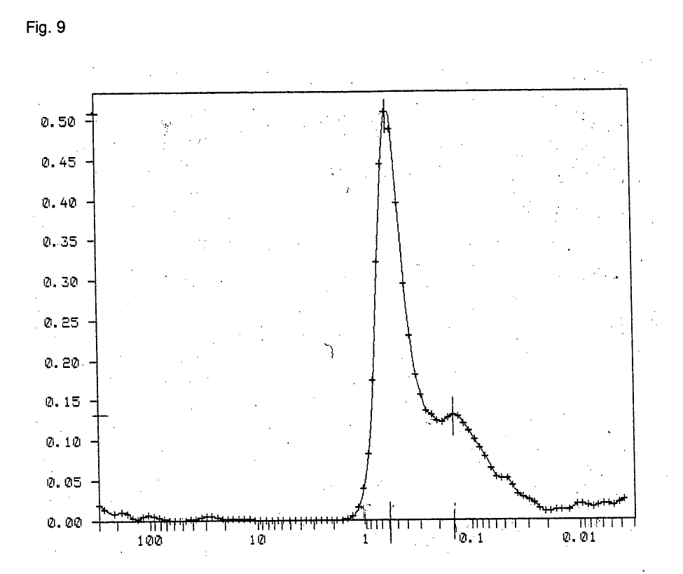

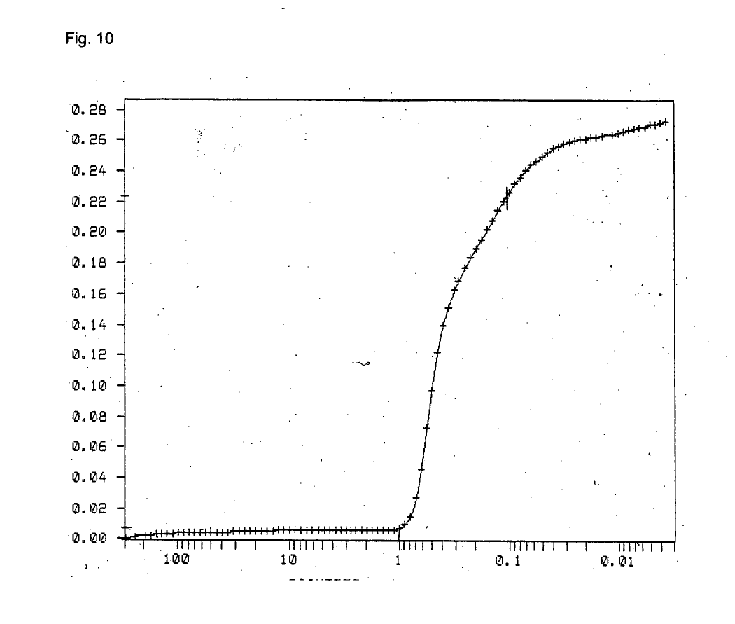

FIGS. 7 and 8 also show the pore distribution of the annular unsupported catalyst CUC3 for two independent reproductions. On the abscissa is plotted the pore diameter in μm. On the left ordinate is plotted the logarithm of the different contribution in ml/g of the particular pore diameter to the total pore volume (+curve). The maximum indicates the pore diameter having the greatest contribution to the total pore volume. On the right ordinate is plotted, in ml/g, the integral over the individual contributions of the individual pore diameters to the total pore volume (O curve). The end point is the total pore volume. FIGS. 9 and 10 show the pore distribution of a further reproduction of CUC3 with the same axis titling as in FIG. 7, 8.

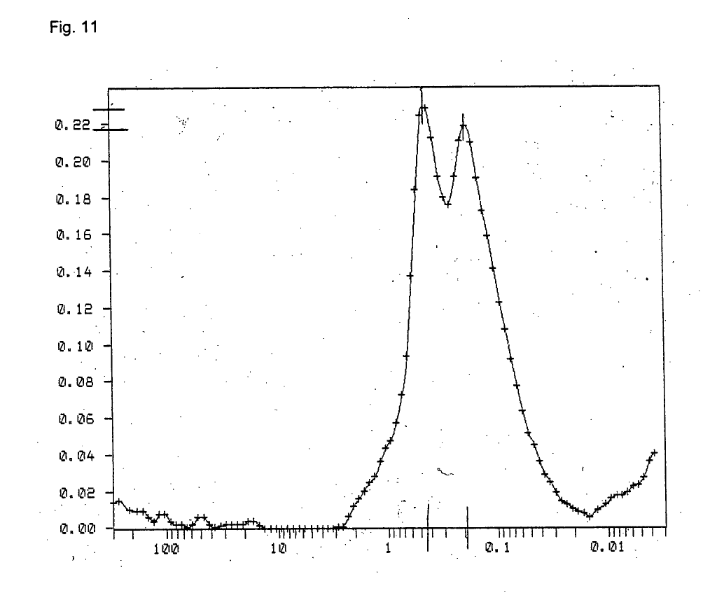

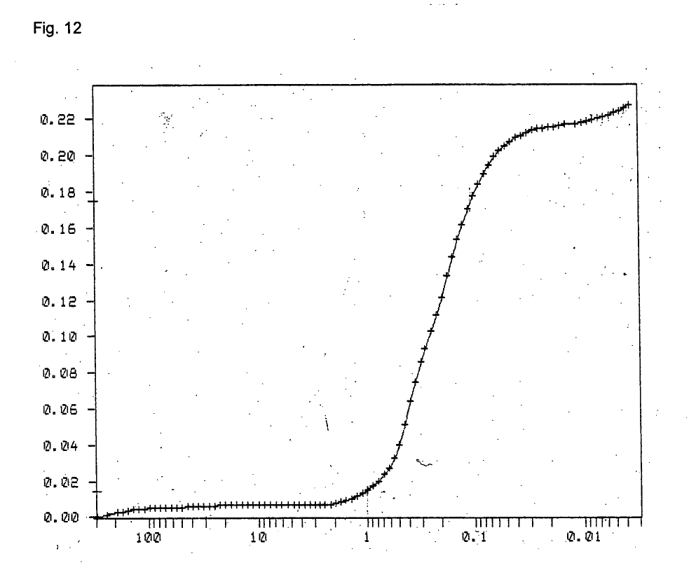

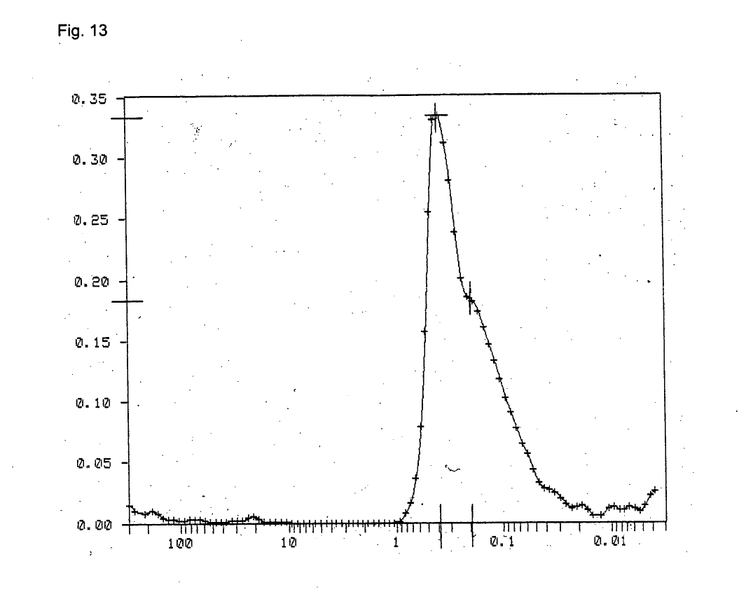

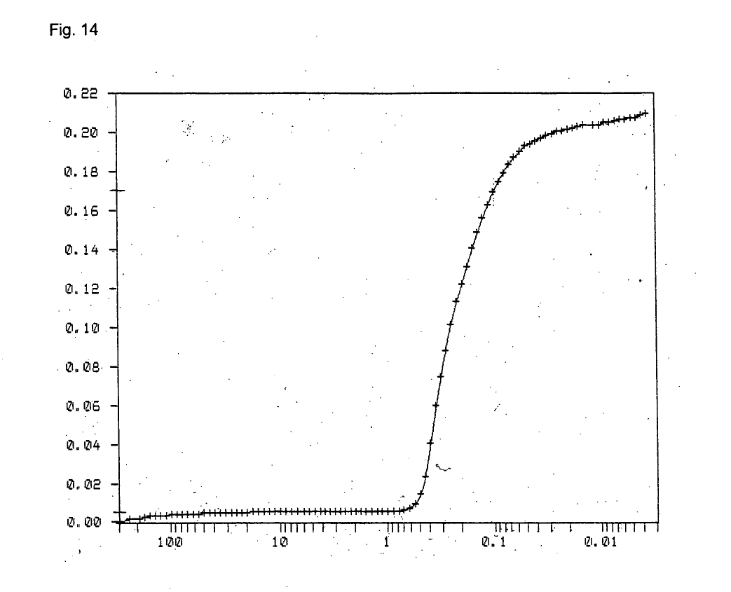

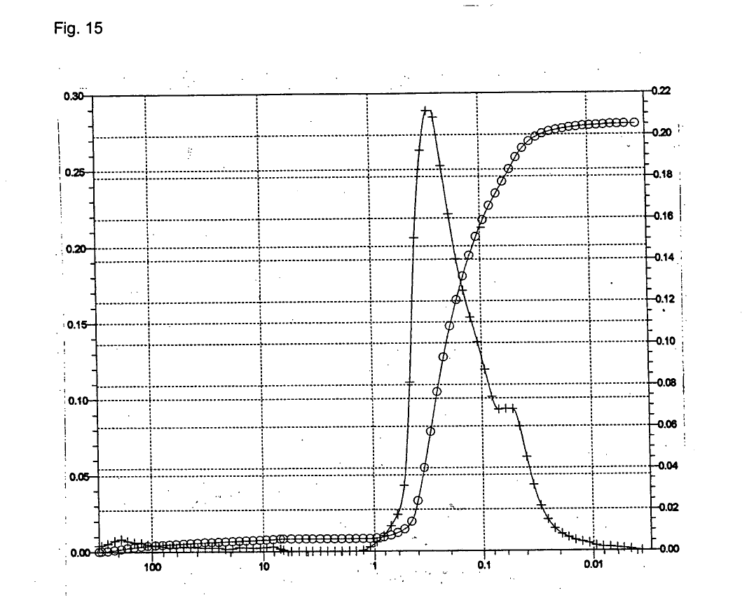

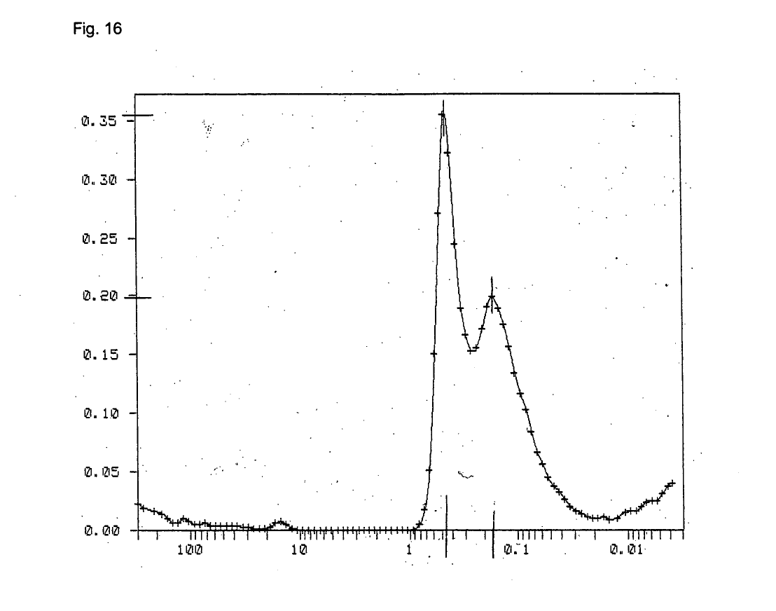

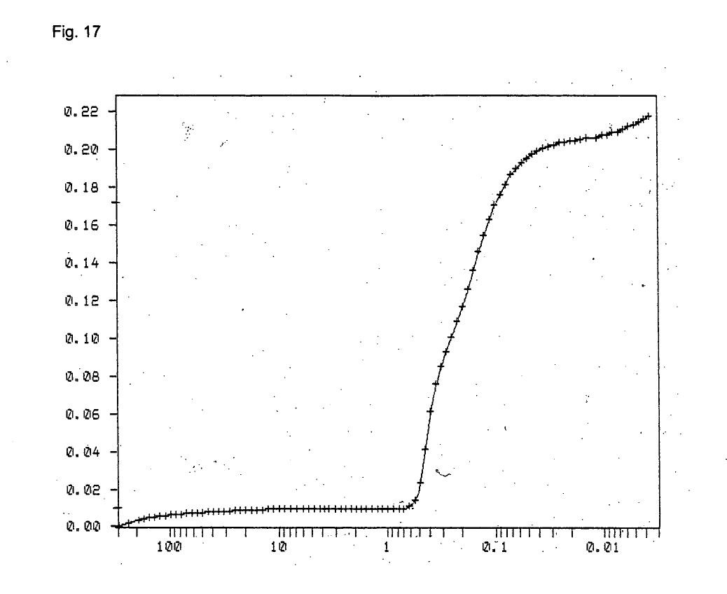

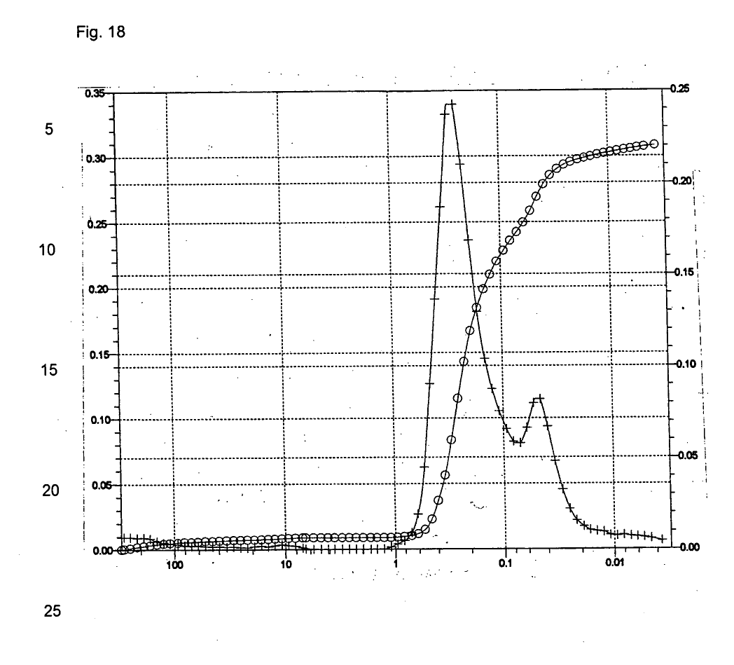

Corresponding figures are FIGS. 11, 12 (CUC4), FIGS. 13, 14 (CUC6), FIG. 15 (CUC7), FIGS. 16, 17 (CUC8) and FIG. 18 (CUC9).

Instead of carrying out the thermal treatment as described, it may also be carried out by means of a belt calcining apparatus as described in Example 1 of DE-A 100 46 957 (however, the bed height in the decomposition (chambers 1 to 4) is advantageously 44 mm at a residence time per chamber of 1.46 h and, in the calcination (chambers 5 to 8), it is advantageously 130 mm at a residence time of 4.67 h); the chambers have a surface area (with a uniform chamber length of 1.40 m) of 1.29 m² (decomposition) and 1.40 m² (calcination) and are flowed through from below through the coarse-mesh belt by 75 m³/(STP)/h of forced air which is aspirated by means of rotating ventilators. Within the chambers, the temporal and local deviation of the temperature from the target value is always ≦2° C. Otherwise, the procedure is as described in Example 1 of DE-A 100 46 957. The resulting annular unsupported catalysts, like the annular unsupported catalysts CUC3 to CUC4, may be used for the catalytic partial oxidation in the gas phase of propene to acrolein described hereinbelow.

As a further alternative, the thermal treatment may be carried out in a forced-air furnace (for example in a KA-040/006-08 EW.OH laboratory chamber furnace from Elino or a K 750 from Heraeus) in such a way that the furnace is heated to 270° C. within 6 h and the temperature of 270° C. is subsequently maintained until the forced air is free of nitrous gases. Subsequently, the furnace is heated to a temperature of from 430° C. to 460° C. (preferably to 438° C.) within 1.5 h and this temperature is maintained for 10 h. The air purge flow is 800 l (STP)/h. 1000 g of annular shaped unsupported catalyst precursor bodies are introduced into a rectangular wire basket (10 cm high, area 14 cm×14 cm) in a bed height of approx. 4 cm. The remaining surface area of the carrying basket is covered in an appropriate bed height with steatite rings (as always in the examples and comparative examples, of the C220 type from Ceram Tec, Germany) of the same geometry.

These thermal treatment conditions may also be employed on the annular shaped unsupported catalyst precursor bodies CUP1 and CUP2. All resulting annular unsupported catalysts may be used in the catalytic partial oxidation in the gas phase described by way of example under C).

C) Testing of the Annular Unsupported Catalysts Prepared in I.A) and I.B) for the Heterogeneously Catalyzed Partial Oxidation of Propene to Acrolein

1. Experimental Arrangement

A reaction tube (V2A steel; external diameter 21 mm, wall thickness 3 mm, internal diameter 15 mm, length 100 cm) was charged from top to bottom in the flow direction as follows:
Section 1: length 30 cm
   Steatite rings of geometry 5 mm×3 mm×2 mm (external diameter×length×internal diameter) as a preliminary bed.
Section 2: length 70 cm
   Catalyst charge of the annular unsupported catalysts prepared in A) and B).

The reaction tube was heated with the aid of a salt bath sparged with nitrogen.

2. Experimental Procedure

The experimental arrangement described, in each case freshly prepared, was in each case charged continuously with a charge gas mixture (mixture of air, polymer-grade propylene and nitrogen) of the composition:
5% by volume of propene,
10% by volume of oxygen and
as the remainder up to 100% by volume, N₂
   and the hourly space velocity and the thermostating of the reaction tube was such that the propene conversion C (mol %) on single pass of the charge gas mixture through the reaction tube was continuously about 95 mol %.

The table which follows shows the salt bath temperatures T_{S} (° C.) and also the acrolein selectivities S^{A} achieved (mol %) which are required to achieve conversion, as a function of the selected catalyst charge and propene hourly space velocity (PHSV in l (STP)/l·h) thereon. The results reported always relate to the end of an operating time of 120 h. The selectivity S^{AA} of acrylic acid by-production was in the range from 4 to 17 mol %.

| Annular | | | | |
|---|---|---|---|---|
| unsupported catalyst | PHSV | T_{S} | S^{A} | S^{AA} |
| CUC1 | 50 | 306 | 89.5 | 4.7 |
| CUC2 | 50 | 306 | 89.5 | 4.6 |
| CUC1 | 75 | 310 | 90.5 | 4.9 |
| CUC2 | 75 | 311 | 90.5 | 4.9 |
| CUC1 | 100 | 315 | 90.8 | 5.2 |
| CUC2 | 100 | 318 | 91.1 | 5.1 |
| CUC3 | 50 | 320 | 88.6 | 7.1 |
| CUC4 | 50 | 325 | 86.1 | 8.8 |
| CUC5 | 50 | 322 | 86.6 | 8.9 |
| CUC6 | 50 | 338 | 84.9 | 10.2 |
| CUC7 | 50 | 320 | 90.2 | 5.1 |
| CUC8 | 50 | 343 | 85.0 | 10.3 |
| CUC9 | 50 | 322 | 90.0 | 5.4 |
| CUC10 | 50 | 333 | 93.1 | 5.4 |
| CUC11 | 50 | 333 | 87.9 | 7.6 |

However, the experiments above may also be carried out in a corresponding manner (same target conversion) in a reaction tube of the following type: V2A steel; external diameter 30 mm, wall thickness 2 mm, internal diameter 26 mm, length 350 cm, a thermal tube centered in the middle of the reaction tube (external diameter 4 mm) for accommodating a thermal element by which the temperature may be determined in the reaction tube over its entire length.

In the flow direction, the charge is as follows:
Section 1: length 80 cm
   Steatite rings of geometry 7 mm×7 mm×4 mm (external diameter×length×internal diameter) as a preliminary bed.
Section 2: length 270 cm
   Catalyst charge of the annular unsupported catalysts prepared in A) and B).

The reaction tube is heated by means of a salt bath pumped in countercurrent.

PHSV is selected at a constant 100. The composition of the starting reaction gas mixture is 5.4% by volume of propene, 10.5% by volume of oxygen, 1.2% by volume of COₓ, 81.3% by volume of N₂ and 1.6% by volume of H₂O.

This experimental procedure may also be carried out in a corresponding manner using a catalyst charge whose section 2 has the following configuration (in each case in flow direction):
I. Initially to length 100 cm, a homogeneous mixture of 65% by weight of CUC3 and 35% by weight of steatite rings (5 mm×3 mm×2 mm);
   then to length 170 cm, a homogeneous mixture of 90% by weight of CUC3 and 10% by weight of steatite rings (5 mm×3 mm×2 mm);
      or
II. Initially to length 100 cm, CUC10;
   then to length 170 cm, CUC3;
      or
III. Initially to length 100 cm, a homogeneous mixture of 70% by weight of CUC3 and 30% by weight of steatite rings (5 mm×3 mm×2 mm);
   then to length 170 cm, CUC3.

Tₛ is selected in all cases in such a way that C-propene=95 mol %.

II. Examples of a Heterogeneously Catalyzed Partial Oxidation of Propene to Acrolein

The annular unsupported catalysts CUC1 to CUC11 were prepared once again as described in I. (i.e. with identical active composition), but with the difference that the TIMREX T44 from Timcal AG used additionally as an assistant in the preparations in I. was replaced in all cases by a corresponding weight of the Boron Nitride Grade A 01, Number PD-5006, Issue 0-07.99, HS Number: 28500030 from H. C. Starck already described in this document.

Annular unsupported catalysts EUC1 to EUC11 were thus obtained (the first letter E stands in each case for Example), whose physical properties (for example S, V, d^{max}, V^{0.1}₁, and R) were not distinguishable from those of the comparative catalysts CUC1 to CUC11 within the limits of reproducibility.

The same was found for the values of Tₛ, S^{A} and S^{AA} in the testing of the annular unsupported catalysts EUC1 to EUC11 as catalysts for a heterogeneously catalyzed partial oxidation of propene to acrolein under the test conditions described in I. C). The process variants described in I. for the comparative unsupported catalysts CUC1 to CUC11 in their preparation and/or testing thus also apply to the unsupported catalysts CUC1 to CUC11.

III. Examples of a Heterogeneously Catalyzed Partial Oxidation of Methacrolein to Methacrylic Acid

A) Preparation of Annular Unsupported Catalysts with the Following Stoichiometry Mo₁₂P_{1.5}V_{0.6}Cs_{1.0}Cu_{0.5}Sb₁S_{0.04}Oₓ of the active composition

537.5 kg of ammonium heptamolybdate tetrahydrate ((NH₄)₆Mo₇O₂₄.4H₂O (81% by weight of MoO₃, 8% by weight of NH₃, ≦50 ppm by weight of Na and ≦100 ppm by weight of K)) were metered with stirring (70 revolutions per minute (rpm)) into 619 l of water heated to 45° C. in a water-heated jacketed vessel. When this was done, the temperature of the solution fell to 37° C. In order to ensure reliable dissolution of the ammonium heptamolybdate, stirring was continued for another 15 minutes after the end of the metered addition, in the course of which the temperature of 37° C. was retained. With further stirring at the same temperature, 17.82 kg of ammonium metavanadate (NH₄VO₃, 77% by weight of V₂O₅, 14.5% by weight of NH₃, ≦150 ppm by weight of Na and ≦500 ppm by weight of K) were metered in within 3 minutes. The mixture was stirred for a further 2 minutes. Then, within one minute, a colorless, clear solution, prepared in a separate dissolution vessel, of 49.6 kg of cesium nitrate (CsNO₃ with 72% by weight of Cs₂O and ≦50 ppm by weight of Na, ≦100 ppm by weight of K, ≦10 ppm by weight of Al and ≦20 ppm by weight of Fe) in 106 l of water at 60° C. was stirred in. As this was done, the temperature of the resulting suspension rose to 39° C. After stirring for a further one minute, 31.66 l of 75% by weight phosphoric acid (density at 25° C. and 1 atm: 1.57 g/ml, viscosity at 25° C. and 1 atm: 0.147 cm²/S) were metered in with continued stirring within a further minute. Owing to the exothermic reaction, the temperature rose to 42° C. as this was done. The mixture was again stirred for a further 1 minute. Then, within one minute, 1.34 kg of ammonium sulfate ((NH₄)₂SO₄ (>99% by weight)) was stirred in and the mixture was stirred for 1 further minute. With continued stirring at identical temperature, 37.04 kg if antimony trioxide (Sb₂O₃, mean particle diameter D₅₀=approx. 2 μm, crystal structure according to XRD:>75% senarmontite, <25% valentinite, purity:>99.3% by weight, ≦0.3% by weight of As₂O₃, ≦0.3% by weight of PbO and ≦300 ppm by weight of FeO) were added within 3 minutes (commercially available as Triox White, Code No. 639000 from Antraco, D-10407 Berlin). The stirrer speed was then reduced from 70 to 50 rpm. Subsequently, the stirred suspension was heated in a linear manner to 95° C. within 30 minutes by means of steam in the jacket. At this temperature and 50 rpm, 51.64 kg of copper nitrate solution (aqueous Cu(NO₃)₂ solution with 15.6% by weight of Cu) were added within 4 minutes. After stirring at 95° C. for a further 4 minutes, the stir speed was reduced further from 50 to 35 rpm. Subsequently, the entire suspension was discharged within 4 minutes into a nitrogen-blanketed spray tower reservoir vessel heated to 85° C. and stirred at 35 rpm, and the jacketed vessel was rinsed with 20 l of water (25° C.). From the reservoir vessel, the suspension was spray-dried in a rotary disk spray tower in countercurrent with an inlet temperature of 285° C. and an outlet temperature of 110° C. within 3.5 h, the resulting spray powder having an ignition loss (1 h at 500° C. in air) of approx. 16% by weight.

The spray powder was mixed homogeneously with 1.5% by weight of boron nitride (Boron Nitride Grade A01, Number PD-5006, Issue 0-07.99 from H. C. Starck) and compacted (K200/100 compactor from Hosokawa Bepex GmbH, D-74211 Leingarten, with concave, fluted smooth rollers, gap width: 2.8 mm, sieve width: 1.25 mm, undersize particle sieve width: 400 μm, screw rotation speed: from 65 to 70 rpm). For the tableting, a further 1% by weight of the same boron nitride was mixed into the compactate. Subsequently, the compactate was tableted in a Kilian rotary tableting press (R×73 tableting machine from Kilian, D-50735 Cologne) under a nitrogen atmosphere to annular solid ring tablets of geometry 7 mm×7 mm×3 mm (external diameter×length×internal diameter) with a side crushing strength of 35±2 N.

8 kg of the crude tablets were distributed uniformly in a wire vessel of surface area 33.0 cm×49.5 cm to give a bed height of 4 cm. The wire vessel was arranged in a chamber oven (from Elino Industrie-Ofenbau, Carl Hanf GmbH & Co, D-52355 Düren, type KA-040/006-08 EW.OH, dimensions: length=57 cm, width=57 cm, height=80 cm) such that uniform flow through the bed of tablets was possible. 2 m³ (STP)/h of fresh air were supplied and the air circulation in the oven was adjusted such that the bed was flowed through at a speed of 0.9 m/s (determined by means of Aerometer from Testo, type 445). The oven was then heat to 380° C. with the following temperature ramp: heat to 180° C. for 40 min, maintain for 30 min, heat to 220° C. within 10 min, maintain for 30 min, heat to 270° C. for 13 min, maintain for 30 min, heat to 340° C. within 25 min and then to 380° C. within 40 min. This temperature was then held for 390 min. During this the NH₃ content in the thermal treatment atmosphere sucked out was monitored continuously by FTIR spectroscopy (“Impact” spectrometer from Nicolet, IR stainless steel cell with CaF₂ window, path length 10 cm, heating to 120° C., determination of the concentration with reference to the intensity of the band at 3.333 cm⁻¹). The NH₃ content remained ≦2.4% by volume over the entire thermal treatment. This maximum value was attained at 220° C. The annular shaped catalyst bodies EUC12 thus obtained had a side crushing strength of 15±2 N, an ammonium content (determined by titration according to Kjeldahl) of 0.3% by weight of NH₄⁺ and an MoO₃ content of 2 XRD intensity %. The latter is calculated as the ratio of the intensity of the (021) MoO₃ reflection at 2Θ=27.3° to the intensity of the (222) reflection of the heteropoly compound at 2Θ=26.5° in the X-ray powder diffractogram (with Cu-Kα radiation).

(Alternatively to the calcination in the chamber furnace described, the calcination can also be effected here in the belt calciner as described in Example I.A.)

B) Testing of the Annular Unsupported Catalysts from II. A for a Heterogeneously Catalyzed Partial Oxidation of Methacrolein to Methacrylic Acid

2 kg of the annular shaped catalyst bodies EUC12 thus prepared were charged, together with a downstream and an upstream bed of 50 g each of steatite rings (steatite C220 from CeramTec) of geometry 7 mm×7 mm×4 mm external diameter×length×internal diameter, into a model tube made of stainless steel (external diameter=30 mm, internal diameter=26 mm, length=4.15 m) (fill height: 397 cm). This was disposed in a nitrogen-sparged salt bath heated to 287° C. The catalytic testing was effected in cycle gas mode: the reactor outlet gas was conducted to a Venturi nozzle, quenched there with water at 75° C. and then passed into the bottom of the distillation column A heated to 75° C. Approx. 55 kg/day of a mixture of reaction product and water (typically approx. 9.5% by weight of methacrylic acid, approx. 0.8% by weight of acetic acid and approx. 0.1% by weight of acrylic acid in water) were withdrawn here. The depleted gas stream passed into column A. In the middle thereof, a substream was withdrawn and passed from below into a column B heated to 7° C. A solution of 6% by weight of hydroquinone in water (2 kg/h) fed in at the top of column B was used to free the offgas in this column of the remaining organic components and the offgas escaped at the top of the column. The contents of the bottom of column B (essentially approx. 1.4% by weight of methacrolein in water) were pumped to the top of column A; there, an additional 220 g/h of methacrolein were fed in. At the top of column A, 1700 l (STP)/h of cycle gas were withdrawn at a top temperature of 66° C., mixed with 450 l (STP)/h of fresh air and passed into the reactor as a reactant gas which comprised approx. 5% by vol. of methacrolein, approx. 12% by vol. of O₂, approx. 21% by vol. of steam, approx. 2.5% by vol. of CO, approx. 3% by vol. of CO₂ and further inert gas (substantially nitrogen). This gave rise to a mass-based weight hourly space velocity (WHSV) of 0.17 h⁻¹.

During the 5-day testing, the methacrolein conversion in single pass was kept at 65 mol %; to this end, the salt bath temperature was increased step by step to 291° C. On day 5, a selectivity for methacrylic acid of 85.0 mol % was obtained. The by-products formed were (with reporting of the selectivities) 4.8 mol % of CO₂, 4.8 mol % of acetic acid, 4.1 mol % of CO, 0.7 mol % of acrylic acid and 0.6 mol % of maleic acid.

IV. Comparative Examples for a Heterogeneously Catalyzed Partial Oxidation of Methacrolein to Methacrylic Acid

The annular unsupported catalyst EUC12 from III. was prepared once again as described in III. (i.e. with identical active composition), but with the difference that the boron nitride used additionally as an assistant in the preparation in III. was replaced by corresponding weights of TIMREX T44 Graphite from Timcal AG.

The annular comparative unsupported catalysts CUC12 thus obtained have an ammonium content of 0.3% by weight of NH₄+ and an MoO₃ content of 2 XRD intensity %.

They were subsequently tested as described in III. B. On day 5 of the catalytic testing under the conditions described in III. B, a salt bath temperature of 292° C. was required. A selectivity for methacrylic acid of 84.6 mol %, was obtained; the by-products formed were (with reporting of the selectivities) 5.0 mol % of CO₂, 4.8 mol % of acetic acid, 4.3 mol % of CO, 0.7 mol % of acrylic acid and 0.6 mol % of maleic acid.

What is claimed is:

1. A process for preparing shaped catalyst bodies whose active composition is a multielement oxide, in which a finely divided precursor mixture which comprises an added finely divided shaping assistant is shaped to the desired geometry and the resulting shaped catalyst precursor bodies are treated thermally at elevated temperature to obtain the shaped catalyst bodies whose active composition is a multielement oxide, wherein the finely divided precursor mixture comprises added boron nitride as the shaping assistant.

2. The process according to claim 1, wherein the added boron nitride comprises ≦5% by weight of B₂O₃.

3. The process according to claim 1, wherein the added boron nitride comprises ≦3% by weight of B₂O₃.

4. The process according to claim 1, wherein the added boron nitride comprises ≦1% by weight of B₂O₃.

5. The process according to any of claims 1 to 4, wherein the added boron nitride comprises ≧0.05% by weight of B₂O₃.

6. The process according to any of claims 1 to 5, wherein the particle diameter of the added boron nitride is within the range from 1 μm to 50 μm.

7. The process according to any of claims 1 to 5, wherein the particle diameter of the added boron nitride is within the range from 1 μm to 10 μm.

8. The process according to any of claims 1 to 7, wherein the finely divided precursor mixture, based on its total weight, comprises from 0.1 to 20% by weight of added boron nitride.

9. The process according to any of claims 1 to 7, wherein the finely divided precursor mixture, based on its total weight, comprises from 0.3 to 8% by weight of added boron nitride.

10. The process according to any of claims 1 to 9, wherein the added boron nitride is present to an extent of at least 50% by weight in hexagonal phase.

11. The process according to any of claims 1 to 9, wherein the added boron nitride is present to an extent of at least 75% by weight in hexagonal phase.

12. The process according to any of claims 1 to 11, wherein the added boron nitride has the following properties:

| | |
|---|---|
| particle diameter: | from 1 to 10 μm, |
| specific surface area: | from 5 to 20 m²/g, |
| bulk density: | from 0.2 to 0.6 g/cm³, and |
| tap density: | from 0.3 to 0.7 g/cm³. |

13. The process according to any of claims 1 to 11, wherein the added boron nitride has the following properties:

| | |
|---|---|
| particle diameter: | from 1 to 5 μm, |
| specific surface area: | from 5 to 15 m²/g, |
| bulk density: | from 0.2 to 0.6 g/cm³, and |
| tap density: | from 0.3 to 0.7 g/cm³. |

14. The process according to any of claims 1 to 13, wherein the shaped catalyst precursor bodies are treated thermally at temperatures of from 150° C. to 650° C.

15. The process according to any of claims 1 to 14, wherein the shaped catalyst precursor bodies are treated thermally in oxidizing atmosphere.

16. The process according to any of claims 1 to 14, wherein the shaped catalyst precursor bodies are treated thermally in an air stream.

17. The process according to any of claims 1 to 16, wherein the particle diameters of the finely divided precursor mixture, excluding the added shaping assistant, are within the range from 1 to 2000 μm.

18. The process according to any of claims 1 to 17, wherein the shaping to the desired geometry is effected by tableting.

19. The process according to any of claims 1 to 18, wherein the shaping is effected with application of a shaping pressure of from 50 kg/cm² to 5000 kg/cm².

20. The process according to any of claims 1 to 19, wherein the shaped catalyst body is a sphere having a diameter of from 2 to 10 mm.

21. The process according to any of claims 1 to 19, wherein the shaped catalyst body is a solid cylinder whose external diameter and length are from 2 to 10 mm.

22. The process according to any of claims 1 to 19, wherein the shaped catalyst body is a ring whose external diameter and length are from 2 to 10 mm and whose wall thickness is from 1 to 3 mm.

23. The process according to any of claims 1 to 22, wherein the active composition is a multimetal oxide.

24. The process according to any of claims 1 to 22, wherein the active composition is a multielement oxide composition which comprises
a) the elements Mo, Fe and Bi or
b) the elements Mo and V or
c) the elements Mo, V and P or
d) the elements V and P.

25. The shaped catalyst body obtainable by a process according to any of claims 1 to 24.

26. A shaped catalyst body whose active composition is a multielement oxide which comprises from 0.1 to 20% by weight of boron nitride.

27. A process for a heterogeneously catalyzed gas phase reaction, wherein the catalyst comprises at least one shaped catalyst body according to claim 25 or 26.

28. The process according to claim 27, wherein the heterogeneously catalyzed gas phase reaction is a heterogeneously catalyzed partial oxidation of an organic compound.

29. The process according to claim 28, wherein the heterogeneously catalyzed partial oxidation is the partial oxidation of propene to acrolein and/or acrylic acid.

30. The process according to claim 28, wherein the heterogeneously catalyzed partial oxidation is the partial oxidation of propane to acrylic acid.

31. The process according to claim 28, wherein the heterogeneously catalyzed partial oxidation is the partial oxidation of methacrolein to methacrylic acid.

32. The process according to claim 28, wherein the heterogeneously catalyzed partial oxidation is the partial oxidation of a hydrocarbon having at least 4 carbon atoms to maleic anhydride.

33. The process according to claim 28, wherein the heterogeneously catalyzed partial oxidation is the partial oxidation of isobutene to methacrolein.
